SEQUENCE LISTING (5 sequences)

SEQ ID NO: 1 - DNA, 41 bp, artificial
  This is a synthetic DNA sequence that is used as probe in the invention
hsccccccttttttccctgagtgtcagatacagcccagtag

SEQ ID NO: 2 - DNA, 41 bp, artificial; identical to SEQ ID NO: 1
  This is a synthetic DNA sequence that is used as a probe in the present invention

SEQ ID NO: 3 - RNA, 55 nt, artificial
  This is a synthetic DNA sequence that hybridize with 16S rRNA
ugggaagaacaucgguggcgaaagcgagcuacugggcuguaucugacacucaggg

SEQ ID NO: 4 - DNA, 31 bp, Artificial Sequence
  This is a synthetic DNA sequence that is used as probe in the present invention
cgccaccgatgttcttcccattttttcccsh

SEQ ID NO: 5 - DNA, 22 bp, artificial
  This is a synthetic random DNA sequence of length 22 nucleotides used as negative control in the present invention
nnnnnnnnnnnnnnnnnnnnnn

(19) United States
(12) Patent Application Publication
(10) Pub. No.: US 2014/0360890 A1
(43) Pub. Date: Dec. 11, 2014

(54) ASYMMETRIC SENSORS

(71) Applicants: Rajakkannu Mutharasan, Philadelpha, PA (US); Blake N. Johnson, Philadelphia, PA (US); Harsh Sharma, Philadelphia, PA (US)

(72) Inventors: Rajakkannu Mutharasan, Philadelpha, PA (US); Blake N. Johnson, Philadelphia, PA (US); Harsh Sharma, Philadelphia, PA (US)

(73) Assignee: Drexel University, Philadelphia, PA (US)

(21) Appl. No.: 14/301,862

(22) Filed: Jun. 11, 2014

Related U.S. Application Data
(60) Provisional application No. 61/833,717, filed on Jun. 11, 2013.

(51) Int. Cl. G01N 27/30

(52) U.S. Cl. CPC G01N 27/30
USPC 205/775; 204/400

(57) ABSTRACT

Cantilever Sensors made of piezoelectric material may be structured with various configurations of asymmetric anchors as well as asymmetric electrodes. Such asymmetry enables measurement of resonant properties of the cantilever that are otherwise unmeasurable electrically, resulting in significant advantages for ease of measurement. In addition the asymmetry enables expression of torsional and/or lateral modes that are otherwise absent, and these modes also exhibit excellent mass-change sensitivity. The asymmetries may enable resonant mode impedance-coupling.

### STATEMENT OF FEDERALLY SPONSORED RESEARCH

Portions of the herein disclosure have been supported in part by a grant from NSF, Grant number is CBET-0828987, and fund budget number is 235523. The government has certain rights in the invention.

### TECHNICAL FIELD

The technical field generally relates to sensors, and more specifically relates to sensors with asymmetrical structures.

### BACKGROUND

Resonant-mode cantilever sensors may respond to an attached mass of analyte by reduction in resonant frequency. The change in resonant frequency may be proportional to analyte concentration, and may be measured by a variety of methods, which may include integrated transducing elements within the oscillating cantilever and external instrumentation that measures the cantilever oscillation amplitude. In both cases, the actuation of the cantilever may be provided by natural thermal fluctuations or by actuating the base of the cantilever electromechanically.

### SUMMARY

Example sensor structures as described herein may express torsional and/or lateral modes that have excellent mass-change sensitivity. Various example configurations include cantilever sensors having multiple types of anchor asymmetry and/or electrode asymmetry that induce expression of torsional and/or lateral modes. The anchor asymmetry may enable resonant mode impedance-coupling.

In various example embodiments, sensors may comprise asymmetric electrodes that may express torsional and/or lateral modes that exhibit mass-change sensitivity to molecular self-assembly on gold (75-135 fg/Hz). The exhibited mass-change sensitivity may be superior to that of widely investigated bending modes. An example sensor may comprise a lead zirconate titanate (PZT) millimeter-sized cantilever sensor comprising anchor asymmetry and/or electrode asymmetry that may induce expression of torsional and/or lateral modes, and/or bending modes in a frequency range of about 0-80 kHz. Additionally, the asymmetric structures may enable resonant mode impedance-coupling.

Various example asymmetric structures are described herein. One example structure may comprise electrode asymmetry in both length and width dimensions. This structure may express both bending and torsional modes. Another example structure may comprise asymmetric electrodes such that a larger sensing area resides on one side of the sensor than on the other side of the sensor. This structure may cause an asymmetry in the added mass which may bind to the deposited Au along the length. Yet another example structure may comprise asymmetric electrodes wherein the area of the electrodes varies in the width and length.

Experiments, analytical models, and finite element simulations described herein illustrate that asymmetry may enable resonant mode impedance-coupling. The sensitive torsional and lateral modes may enable measurement of self-assembled monolayer formation rate.

In other exemplary embodiments, the method may comprise the step of exposing at least a portion of a sensor to a medium, wherein the sensor comprises a first portion comprising a first surface and a second surface; wherein the first surface is opposite the second surface; a first electrode is coupled to the first surface of the first portion; and a second electrode is coupled to the second surface of the first portion, wherein the first electrode and the second electrode are asymmetric; measuring a resonance frequency of the sensor; comparing the measured resonance frequency with a baseline frequency; and when the measured resonance frequency differs from the baseline frequency, determining that an analyte is present in the medium.

In another embodiment, in the sensor in the method the length of the first electrode differs from a length of the second electrode.

In another embodiment, the sensor in the method has a width of the first electrode that differs from a width of the second electrode.

In another embodiment, the sensor in the method has a placement of the first electrode with respect to the first surface that differs from a placement of the second electrode with respect to the second surface.

In another embodiment, the sensor in the method has an end of the first electrode that is angled.

In another embodiment, the sensor in the method has an end of the second electrode that is angled.

In another embodiment, the first portion of the sensor in the method comprises a piezoelectric material.

In another embodiment, the sensor in the method is configured as a cantilever sensor.

In yet another exemplary embodiment, the method may comprise exposing at least a portion of a sensor to a medium, wherein the sensor comprises a first portion comprising a first surface and a second surface; wherein the first surface is opposite the second surface; a first electrode is coupled to the first surface of the first portion; and a second electrode is coupled to the second surface of the first portion, wherein the first electrode and the second electrode are asymmetric; measuring an impedance of the sensor; comparing the measured impedance with a baseline impedance; and when the measured impedance differs from the baseline impedance, determining that an analyte is present in the medium.

In another embodiment, the sensor in the method has a length of the first electrode that differs from a length of the second electrode.

In another embodiment, the sensor in the method has a width of the first electrode that differs from a width of the second electrode.

In another embodiment, the sensor in the method has a placement of the first electrode with respect to the first surface that differs from a placement of the second electrode with respect to the second surface.

In another embodiment, the sensor in the method has an end of the first electrode that is angled.

In another embodiment, the sensor in the method has an end of the second electrode that is angled.

In another embodiment, the first portion of the sensor in the method comprises a piezoelectric material.

In another embodiment, the sensor in the method is configured as a cantilever sensor.

In yet another exemplary embodiment, the method may comprise exposing at least a portion of a sensor to a medium, wherein the sensor comprises a first portion comprising a first surface and a second surface; wherein the first surface is opposite the second surface; a proximate end opposite a distal end; and a first side opposite a second side; and an asymmetrically configured base coupled to the first portion; measuring a resonance frequency of the sensor; comparing the measured resonance frequency with a baseline frequency; and when the measured resonance frequency differs from the baseline frequency, determining that an analyte is present in the medium.

In another embodiment, the sensor in the method has the base coupled to only one of the first side or the second side.

In another embodiment, the sensor in the method has the base is coupled to only one of the first surface or the second surface.

In another embodiment, the sensor in the method has a length of a portion of the base coupled to the first surface that differs from a length of a portion of the base coupled to the second surface.

In another embodiment, the sensor in the method has a length of a portion of the base coupled to the first side that differs from a length of a portion of the base coupled to the second side.

In another embodiment, the sensor in the method has a width of a portion of the base coupled to the first surface that differs from a width of a portion of the base coupled to the second surface.

In another embodiment, the sensor in the method has a width of a portion of the base coupled to the first side that differs from a width of a portion of the base coupled to the second side.

In another embodiment, the sensor in the method has an end of the base that is angled.

In another embodiment, the first portion of the sensor in the method comprises a piezoelectric material.

In another embodiment, the sensor in the method is configured as a cantilever sensor.

In yet another exemplary embodiment, the method may comprise exposing at least a portion of a sensor to a medium, wherein the sensor comprises a first portion comprising a first surface and a second surface; wherein the first surface is opposite the second surface; a proximate end opposite a distal end; and a first side opposite a second side; and an asymmetrically configured base coupled to the first portion; measuring an impedance of the sensor; comparing the measured impedance with a baseline impedance; and when the measured impedance differs from the baseline impedance, determining that an analyte is present in the medium.

In another embodiment, the sensor in the method has the base coupled to only one of the first side or the second side.

In another embodiment, the sensor in the method has the base coupled to only one of the first surface or the second surface.

In another embodiment, the sensor in the method has a length of a portion of the base coupled to the first surface that differs from a length of a portion of the base coupled to the second surface.

In another embodiment, the sensor in the method has a length of a portion of the base coupled to the first side that differs from a length of a portion of the base coupled to the second side.

In another embodiment, the sensor in the method has a width of a portion of the base coupled to the first surface that differs from a width of a portion of the base coupled to the second surface.

In another embodiment, the sensor in the method has a width of a portion of the base coupled to the first side that differs from a width of a portion of the base coupled to the second side.

In another embodiment, the sensor in the method has an end of the base that is angled.

In another embodiment, the first portion of the sensor in the method comprises a piezoelectric material.

In another embodiment, the sensor in the method is configured as a cantilever sensor.

In another exemplary embodiment, the present invention provides a method of generating an acoustic stream in a fluid using a sensor, when the sensor is excited with an excitation voltage. The excited sensor causes an oscillating mechanical disturbance in the fluid. The fluid and any suspended particles in the fluid are subject to acoustofluidic forces. Various acoustofluidic effects can arise based on different mechanisms, including acoustic streaming and radiation pressure.

### BRIEF DESCRIPTION OF THE DRAWINGS

The foregoing summary, as well as the following detailed description, may be better understood when read in conjunction with the appended drawings. For the purpose of illustrating asymmetric sensors, exemplary drawings are shown, however, asymmetric sensors, are not limited to the specific methods and instrumentalities illustrated.

FIG. 1 illustrates bending, torsional, and lateral movement of a cantilever.

FIG. 2 is an illustration of an example piezoelectric cantilever sensor comprising a piezoelectric portion and a non-piezoelectric portion.

FIG. 3 is a cross-sectional view of an example piezoelectric cantilever sensor.

FIG. 4 illustrates an example electrode placement on the piezoelectric cantilever sensor.

FIG. 5 illustrates another example electrode placement on the piezoelectric cantilever sensor.

FIG. 6 illustrates an example cantilever sensor anchor structure.

FIG. 7 illustrates another example cantilever sensor anchor structure.

FIG. 8 illustrates another example cantilever sensor anchor structure.

FIG. 9 illustrates another example cantilever sensor anchor structure.

FIG. 10 is a graph comprising plots of frequency versus phase angle for various anchor angles, θ_{T}, which is defined in FIG. 8 Experimental results.

FIG. 11 is a graph comprising plots of simulated frequency versus phase angle for various anchor angles, θ_{T}, which is defined in FIG. 8 Finite element calculation results.

FIG. 12 is a graph that illustrates the results of introduction of lateral anchor asymmetry (α=0.11). Experimental results.

FIG. 13 illustrates FEM frequency response analysis.

FIG. 14 illustrates effect of asymmetry on resonant frequency.

FIG. 15 illustrates effect of asymmetry on cantilever.

FIG. 16 illustrates the effect of non-uniform anchor on mode shape.

FIG. 17 illustrates the deflection profile corresponding to the unmodified side of the cantilever designated as section A in FIG. 14.

FIG. 18 illustrates the deflection profile corresponding to the modified side of the cantilever designated as section B in FIG. 14.

FIG. 19 illustrates the experimentally measured frequency spectra of both sensor configurations in air and liquid.

FIG. 20 illustrates resonant frequency of both modes decreased exponentially over a 35 minute period due to mass increase caused by MCH binding to sensor gold surface.

FIG. 21 illustrates that concentration-dependent binding response of each mode was then measured which showed that torsional modes were also slightly more sensitive than lateral modes at higher analyte binding concentration.

FIG. 22A illustrates an example a symmetric configuration.

FIG. 22B illustrates an asymmetric electrode configuration with asymmetry in the length of the top and bottom exciting Ni electrodes which have previously been treated that expresses bending modes.

FIG. 22C illustrates a proposed configuration with electrode asymmetry in both length and width dimensions for expression of both bending and torsional modes.

FIG. 23A illustrates an example configurationed sensor with symmetrically deposited Au on both sides of the sensor tip.

FIG. 23B illustrates a sensor configuration with a larger sensing area on one side of the sensor causing an asymmetry in the added mass which binds to the deposited Au along the length.

FIG. 23C illustrates a sensor configuration with area that also varies in the width dimension in addition to asymmetric lengths of Au.

FIG. 24A illustrates a sensor configuration which involves bonding over various different lengths.

FIG. 24B illustrates a sensor configuration which involves bonding over various different lengths.

FIG. 24C illustrates an exemplary sensor configuration which extends the idea to bonding the high modulus material at point-wise positionally-dependent locations.

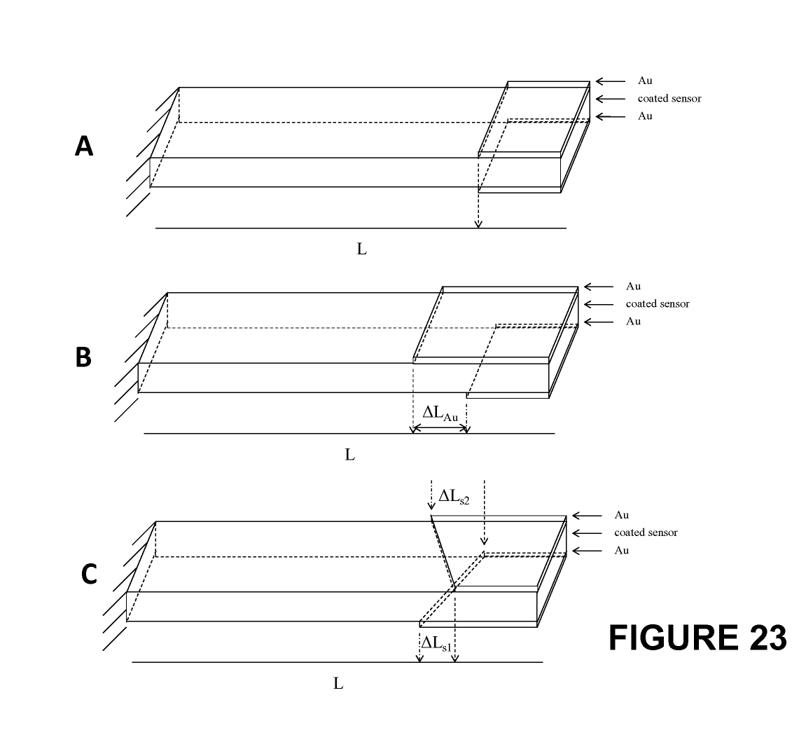

FIG. 23D illustrates an exemplary sensor configuration which extends the idea to bonding the high modulus material at point-wise positionally-dependent locations.

FIG. 25A illustrates a symmetric sensor with uniform E-field.

FIG. 25B illustrates a new sensor with triangular thickness cross section which establishes high strain at the tip greater then strain near the anchor.

FIG. 25C illustrates a new sensor that involves an indented thickness geometry in which field strength is higher in the middle than near the ends.

FIG. 26A is a 2D schematic representation of a cross section of a sensor fabricated in Example 1, showing sensor piezoelectric-polymer-metal composite layers.

FIG. 26B is a 3D schematic representation of the sensor fabricated in Example 1, showing the analyte detecting area at the cantilever distal tip and electrically-insulated conductive path for connecting with instruments.

FIG. 26C is a photograph of the sensor fabricated in Example 1.

FIG. 27A is a schematic representation of charge transfer occurring on the working electrode surface of the sensor fabricated in Example 1.

FIG. 27B is an electromechanical resonance spectrum of the sensor of Example 1 showing the first and second resonant modes.

FIG. 27C is an electrochemical impedance spectrum of the sensor of Example 1 measured in PBS buffered Fe(CN)₆^{4-/3-} when the sensor was in the second resonant mode.

FIG. 28A is a schematic representation of Au thin-film deposition configuration where the anode is solid copper and the cathode is the Au-surface on the sensor.

FIG. 28B shows the response of the first and second resonant modes and voltage during gold deposition cycles on the sensor.

FIG. 28C shows current and resonant frequency transients during one gold deposition cycle.

FIG. 29A is an electrochemical impedance spectrum of the sensor of Example 1 with binding of a protein and thiolated ssDNA.

FIG. 29B shows the electromechanical response for the binding of the same protein and thiolated ssDNA as in FIG. 29A using the sensor of Example 1. The negative control is the response to injection of a solution lacking either the protein or thiolated ssDNA.

FIG. 30 shows simultaneous measurements of resonant frequency and charge transfer resistance of the sensor of Example 1 in response to 6-mercapto-1-hexanol (MCH) chemisorption on the sensor.

FIG. 31A is a schematic representation of an apparatus used for continuous detection of analytes, where the sensor is placed in a flow cell.

FIG. 31B is a schematic representation of the relationship of mass addition to a sensor and the resonant frequency shift of the sensor.

FIG. 31C is a schematic representation of a protocol for detection of 16S rRNA from M. aeruginosa cells, where Au particles are label with a DNA that specifically binds to the 16S rRNA.

FIG. 32A is photographs of a sensor fabricated in Example 2.

FIG. 32B is a photograph of the sensor of Example 2 located in an eppendorf test tube.

FIG. 32C shows the frequency response of the sensor of Example 2 over 0-100 kHz, which displays two mass-sensitive resonant modes at frequencies of about 12 and 60 kHz in air. The resonant frequencies are shifted upon immersion of the sensor in a liquid.

FIG. 33A shows the resonant frequency shift for the sensor of Example 2 in response to immobilization of a DNA probe at different, sequentially increased concentrations.

FIG. 33B shows the relationship between the resonant frequency shift of the sensor of Example 2 and the concentration of the DNA probe used in FIG. 33A over a dynamic range of five log units.

FIG. 34A shows a typical response of the sensor of Example 2 to nucleic acid (NA)-extracts from about 50 cells/mL of M. aeruginosa. One mL of M. aeruginosa NA-extract was used, which resulted in about a 45 Hz resonant frequency decrease.

FIG. 34B shows the resonant frequency shift of the sensor of Example 2 over time when exposed to two different concentrations of NA-extract from M. aeruginosa cells.

FIG. 35A shows the relationship between the resonant frequency shift of the sensor of Example 2 and concentrations of M. aeruginosa NA-extract (cells/mL) over a dynamic range of five log units.

FIG. 35B shows verification of the response of the sensor of Example 2 by secondary binding of DNA probe-labeled gold nanoparticles (gold particle enhancement).

FIG. 36 shows the resonant frequency shift of the sensor of Example 2 after exposure to different concentrations of M. aeruginosa NA-extract, with and without gold nanoparticle enhancement.

FIG. 37A is a schematic representation of the sensor fabricated in Example 3.

FIG. 37B shows the resonant frequency in air and human serum (HS) for the sensor of Example 3 over the 0-200 kHz frequency range as measured under an excitation voltage (Vₑₓ) of 100 mV.

FIG. 38A is a photograph showing initial particle distribution in the suspension and the sensor of Example 3 immersed in the suspension (tracked particle location indicated by the arrow).

FIG. 38B is a photograph showing the particle distribution one second after an excitation voltage of 10 V was applied to the sensor of Example 3 to place the sensor under the influence of acoustic streaming. The location of same tracked particle (indicated by the arrow in FIG. 38A) is indicated by the arrow which lies out of view on the far side of the sensor.

FIG. 39A shows the effect of excitation voltage Vₑₓ on the level of reduction in nonspecific binding (θ_{red}) using electrochemical impedance spectroscopy at different excitation voltages for the sensor of Example 3.

FIG. 39B shows the resonant frequency shift of the sensor of Example 3 during the same process of FIG. 39A.

FIG. 40 shows the effect of excitation voltage Vₑₓ on release of adsorbed BSA protein (θ_{red}) from the sensor of Example 3 measured via NanoOrange assay.

FIG. 41A shows a comparison of a vibration-induced reduction in nonspecific binding (θ_{red}) of proteins and ssDNA using different excitation voltages and the sensor of Example 3.

FIG. 41B shows a curve fitting the empirical relation θ_{red}=1−exp(−αVₙ) to technique-averaged data for both proteins and ssDNA as measured in the same process of FIG. 41A.

FIG. 42 shows charge transfer resistance of the sensor of Example 3 after exposure to different protein concentrations (0.2-3.6 mg/mL) when different excitation voltages Vₑₓ were applied to the sensor.

FIGS. 43A and 43B are photographs of the sensor fabricated in Example 4.

FIG. 43C shows the electrochemical impedance spectrum of the sensor of Example 4 measured at 100 mV AC and 0 V DC bias in air and water.

FIGS. 44A and 44B show the shapes of the sensor of Example 4 at first mode (FIG. 44A, fₙ₌₁) and second mode (FIG. 44B, fₙ₌₂), obtained from 3D finite element modeling simulations.

FIG. 44C shows images of the vibration-induced deflection of the sensor of Example 4 by a density-driven laminar dye stream flowing adjacent to the sensor under different excitation frequencies around the first mode.

FIG. 45A is a photograph of a rotational dye stream flow trajectory established by pulsing the excitation voltage to the sensor of Example 4 on and off at f=fₙ₌₁ at a 3 second interval.

FIG. 45B is a photograph of a deflected dye stream trajectory past the sensor of Example 4 under an excitation voltage in the first mode (n=1, f=fₙ₌₁) with a vertically-positioned sensor.

FIG. 45C is a photograph of a deflected dye stream trajectory past the sensor of Example 4 under an excitation voltage in the second mode (n=2, f=fₙ₌₂) with a vertically-positioned sensor.

FIG. 45D is a photograph of a dye mixing pattern achieved by the sensor of Example 4 under an excitation voltage in the first mode (n=1, f=fₙ₌₁) with a horizontally-positioned sensor.

FIG. 45D is a photograph of a dye mixing pattern achieved by the sensor of Example 4 under excitation voltage in the second mode (n=2, f=fₙ₌₂) with a horizontally-positioned sensor.

FIGS. 46A-46D show particles trapped on the sensor of Example 4 in the first resonant mode at times t=0, 1, 5, and 90 minutes.

FIG. 46E shows particles trapped in the first resonant mode on the sensor of Example 4 at higher particle density (higher than the particle density used in FIGS. 46A-46D) after 20 minutes

FIG. 47A shows the configuration of trapped particles on the sensor of Example 4 at a steady state in the first resonant mode.

FIG. 47B shows intermediate re-arrangement of particles after changing the excitation frequency of the sensor of Example 4 from the first resonant mode to the second resonant mode at time t=0.5s.

FIG. 47C shows particle re-arrangement at a steady state after changing the excitation frequency of the sensor of Example 4 from the first resonant mode to the second resonant mode at time t=∞.

FIG. 48A shows a configuration of trapped particles on the sensor of Example 4 at a steady state at resonant frequency f about 10 kHz in the first resonant mode.

FIG. 48B shows re-arrangement of the trapped particles on the sensor of Example 4 after a change of resonant frequency to 1.8 MHz.

FIG. 48C shows further re-arrangement of the trapped particles on the sensor of Example 4 after a change of resonant frequency to 4.6 MHz.

FIG. 49A shows trapped particles on the sensor of Example 4 in the first resonant mode at steady state.

FIG. 49B shows release of the trapped particles of FIG. 49A via switching to high-order resonant mode excitation using a noise signal at t=0.2s.

FIG. 49C shows release of the trapped particles of FIG. 49A via switching to high-order resonant mode excitation using a noise signal at t=0.4.

FIG. 49D shows release of the trapped particles of FIG. 49A via switching to high-order resonant mode excitation using a noise signal at t=0.6.

FIG. 49E shows release of the trapped particles of FIG. 49A via switching to high-order resonant mode excitation using a noise signal at t=0.8.

FIG. 49F shows release of the trapped particles of FIG. 49A via switching to high-order resonant mode excitation using a noise signal at t=20.

### DETAILED DESCRIPTION OF ILLUSTRATIVE EMBODIMENTS

Novel sensor structures may express torsional and lateral modes that exhibit excellent mass-change sensitivity. As described herein, the sensor structures are applied to lead zirconate titanate (PZT) millimeter-sized cantilever sensors, but it is to be understood that the herein-described sensor structures are not limited to PZT millimeter-sized cantilever sensors.

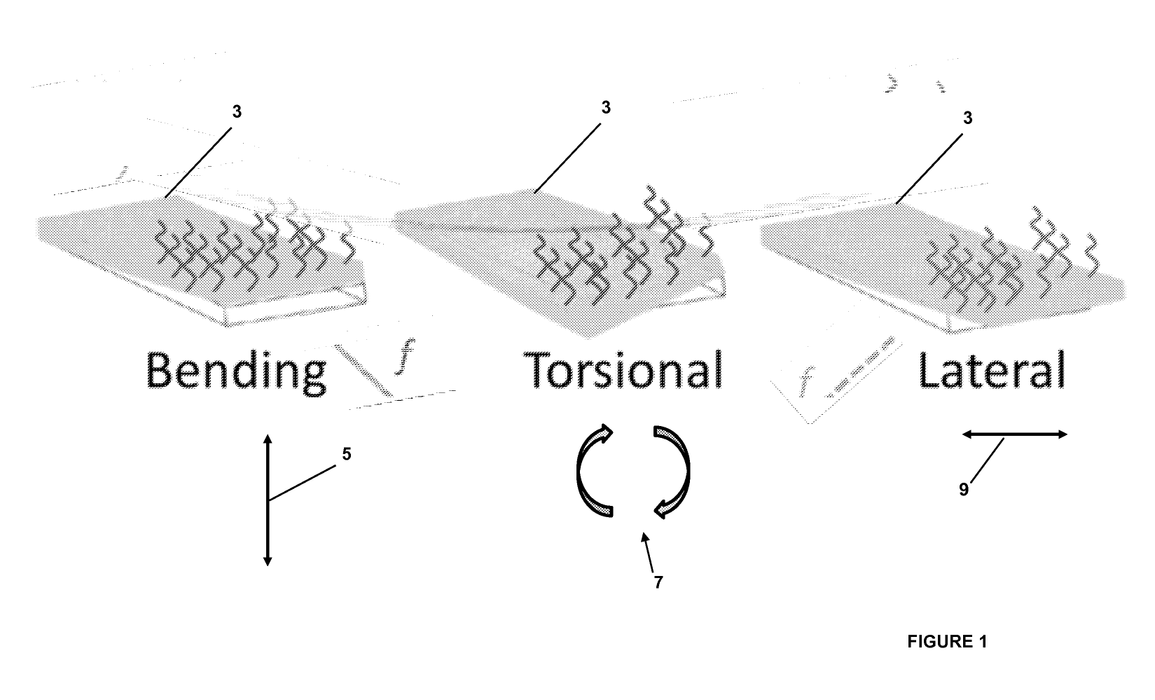

FIG. 1 illustrates bending, torsional, and lateral movement of a cantilever. As shown in FIG. 1, bending refers to a cantilever 3 moving in up and/or down direction as depicted by arrow 5. Torsional refers to the cantilever 3 moving in twisting direction as depicted by arrow 7. And lateral refers to a cantilever 3 moving in a side to side direction as depicted by arrow 9.

An example configuration of a piezoelectric cantilever sensor may comprise a composite structure of non-uniform thickness comprising a piezoelectric material (e.g., lead zirconate titanate, PZT) layer and a glass layer, for example. The PZT layer may act as an actuating and sensing element, while the glass layer may provide a surface for antibody, nucleic acid immobilizations, or the like.

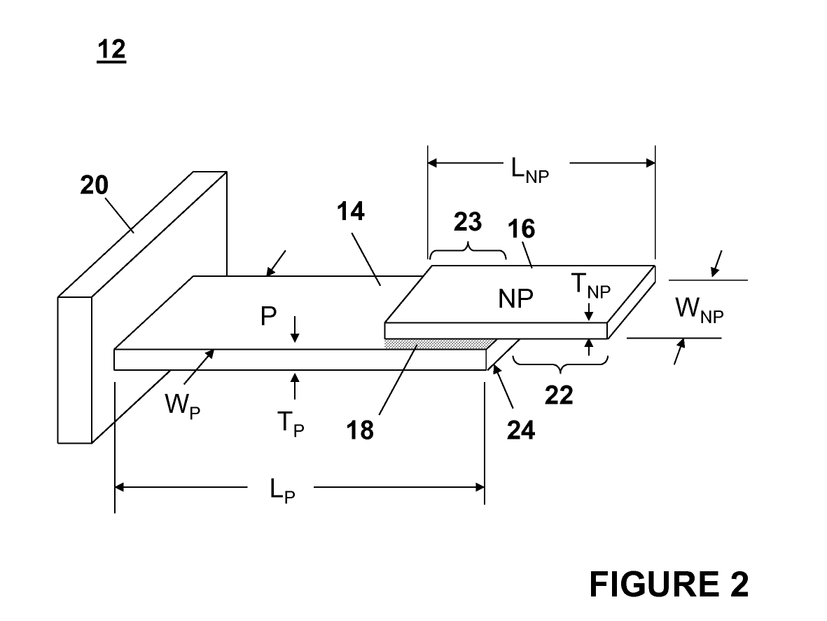

FIG. 2 is an illustration of an example piezoelectric cantilever sensor 12 comprising a piezoelectric portion 14 and a non-piezoelectric portion 16. Piezoelectric portions are labeled with an uppercase letter p (“P”), and non-piezoelectric portions are labeled with the uppercase letters np (“NP”). The piezoelectric cantilever sensor 12 depicts an embodiment of an unanchored, overhang, piezoelectric cantilever sensor. The piezoelectric cantilever sensor 12 is termed “unanchored” because the non-piezoelectric layer 16 is not attached to the base portion 20. The piezoelectric cantilever sensor 12 is termed, “overhang” because the non-piezoelectric layer 16 extends beyond the distal tip 24 of the piezoelectric layer 14 to create an overhanging portion 22 of the non-piezoelectric layer 16. The piezoelectric portion 14 is coupled to the non-piezoelectric portion 16 via adhesive portion 18. The piezoelectric portion 14 and the non-piezoelectric portion overlap at region 23. The adhesive portion 18 is positioned between the overlapping portions of the piezoelectric portion 14 and the non-piezoelectric portion 16. The piezoelectric portion 14 is coupled to a base portion 20.

The piezoelectric portion 14 can comprise any appropriate material such as lead zirconate titanate, lead magnesium niobate-lead titanate solid solutions, strontium lead titanate, quartz silica, piezoelectric ceramic lead zirconate and titanate (PZT), piezoceramic-polymer fiber composites, or the like, for example. The non-piezoelectric portion 16 can comprise any appropriate material such as glass, ceramics, metals, polymers and composites of one or more of ceramics, and polymers, such as silicon dioxide, copper, stainless steel, titanium, or the like, for example.

The piezoelectric cantilever sensor can comprise portions having any appropriate combination of dimensions. Further, physical dimensions can be non-uniform. Thus, the piezoelectric layer and/or the non-piezoelectric layer can be tapered. For example, the length (e.g., L_{P} in FIG. 2) of the piezoelectric portion (e.g., piezoelectric portion 14) can range from about 0.1 to about 10 mm. The length (e.g., L_{NP} in FIG. 2) of the non-piezoelectric portion (e.g., non-piezoelectric portion 16) can range from about 0.1 to about 10 mm. The overlap region (e.g., overlap region 23) can range from about 0.1 to about 10 mm in length. The width (e.g., W_{P} in FIG. 2) of the piezoelectric portion (e.g., piezoelectric portion 14), and the width (e.g., W_{NP} in FIG. 2) of the non-piezoelectric portion (e.g., non-piezoelectric portion 16), can range from about 0.1 mm to about 4.0 mm. The width (e.g., Wₚ in FIG. 2) of the piezoelectric portion can differ from the width (e.g., W_{NP} in FIG. 1) of the non-piezoelectric portion as well. The thickness of the (e.g., Tₚ in FIG. 2) of the piezoelectric portion (e.g., piezoelectric portion 14), and the thickness (e.g., T_{NP} in FIG. 2) of the non-piezoelectric portion (e.g., non-piezoelectric portion 16), can range from about 10 micrometers (10×10⁻⁶ meters) to about 4.0 mm. The thickness (e.g., Tₚ in FIG. 2) of the piezoelectric portion also can differ from the thickness (e.g., T_{NP} in FIG. 2) of the non-piezoelectric portion.

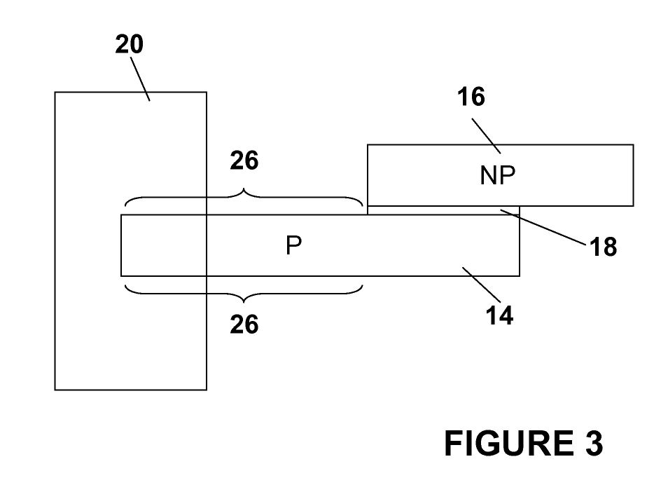

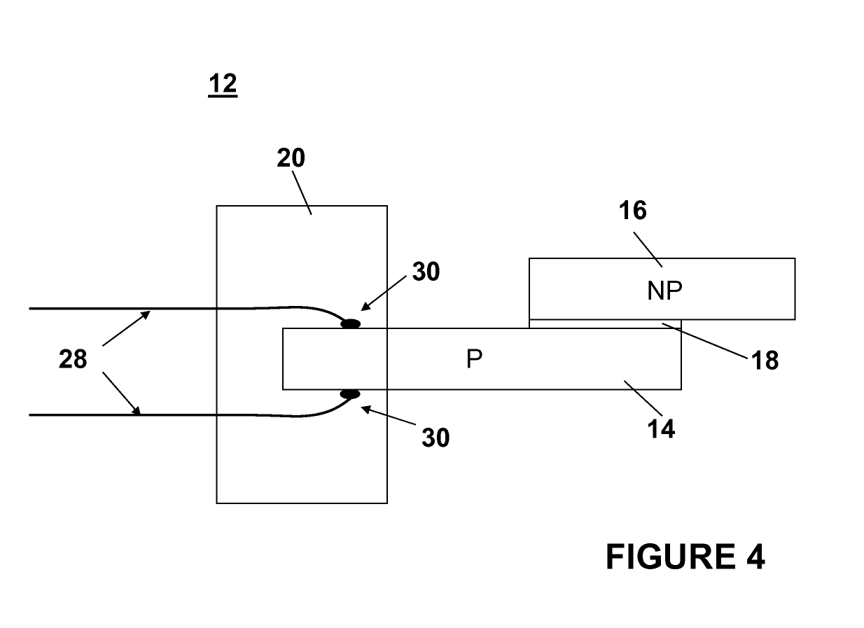

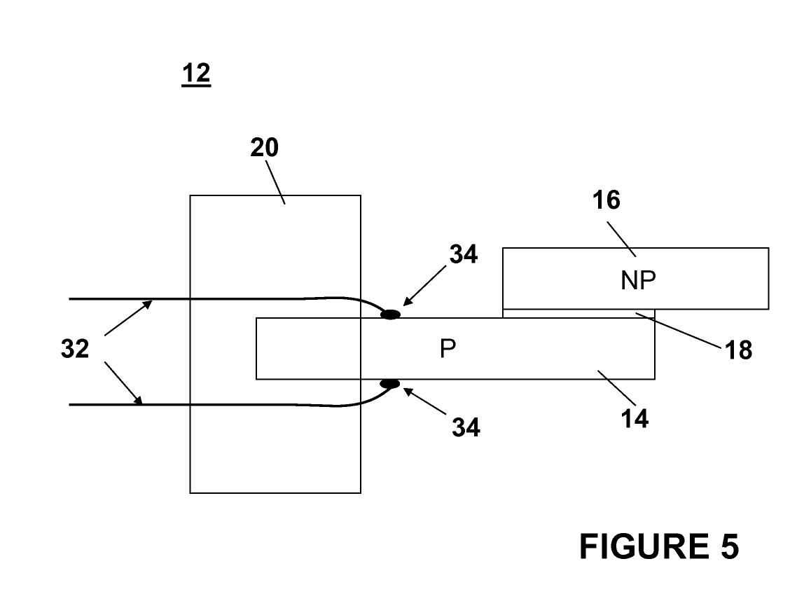

FIG. 3 is a cross-sectional view of the piezoelectric cantilever sensor 12 depicting electrode placement regions 26 for electrodes operationally associated with the piezoelectric portion 14. Electrodes can be placed at any appropriate location on the piezoelectric portion of the piezoelectric cantilever sensor as indicated by brackets 26. For example, as shown in FIG. 4, electrodes 28 can be coupled to the piezoelectric portion 14 within the base portion 20. Or, as depicted in FIG. 5, electrodes 32 can be coupled to the piezoelectric portion 14 at any location not within the base portion 20 and not overlapped by the non-piezoelectric portion 16. Electrodes need not be placed symmetrically about the piezoelectric portion 14. In an example embodiment, one electrode can be coupled to the piezoelectric portion 14 within the base portion 20 and the other electrode can be coupled to the piezoelectric portion 14 not within the base portion 20. Electrodes, or any appropriate means (e.g., inductive means, wireless means), can be utilized to provide an electrical signal to and receive an electrical signal from the piezoelectric portion 14. In an example embodiment, electrodes can be coupled to the piezoelectric portion 14 via a bonding pad or the like (depicted as elements 30 in FIG. 4 and elements 34 in FIG. 5). Example bonding pads can comprise any appropriate material (e.g., gold, silicon oxide) capable of immobilization of a receptor material and/or an absorbent material appropriate for use in chemical sensing or for bio-sensing.

Electrodes may be placed at any appropriate location. In an example embodiment, electrodes may be operatively located near a location of concentrated stress in the piezoelectric layer 14. As described above, the sensitivity of the piezoelectric cantilever sensor is due in part to advantageously directing (concentrating) the stress in the piezoelectric layer 14 and placing electrodes proximate thereto. The configurations of the piezoelectric cantilever sensor described herein (and variants thereof) tend to concentrate oscillation associated stress in the piezoelectric layer 14. At resonance, in some of the configurations of the piezoelectric cantilever sensor, the oscillating cantilever concentrates stress in the piezoelectric layer 14 toward the base portion 20. This may result in an amplified change in the resistive component of the piezoelectric layer 14, and a large shift in resonance frequency at the locations of high stress. Directing this stress to a portion of the piezoelectric layer 14 having a low bending modulus (e.g., more flexible) allows for exploitation of the associated shift in resonance frequency to detect extremely small changes in mass of the piezoelectric cantilever sensor. Thus, in example configurations of the piezoelectric cantilever sensor, the thickness of the piezoelectric layer 14 located near the base portion 20 is thinner than portions of the piezoelectric layer 14 further away from the base portion 20. This may tend to concentrate stress toward the thinner portion of the piezoelectric layer 14. In example configurations, electrodes may be located at or near the locations of the oscillation associated concentrated stress near the base portion of the piezoelectric cantilever sensor. In other example configurations of the piezoelectric cantilever sensor electrodes are positioned proximate the location of concentrated stress in the piezoelectric layer regardless of the proximity of the concentrated stress to a base portion of the piezoelectric cantilever sensor.

The description of piezoelectric cantilever sensors as depicted in FIG. 2 through FIG. 5 and associated text also is applicable to single layer piezoelectric cantilever sensors as described herein.

This disclosure illustrates exemplary cantilever embodiments that express torsional and lateral modes exhibit, for example, mass-change sensitivity to molecular self-assembly on gold (75-135 fg/Hz) which may be superior to that of widely investigated bending modes. Exemplary cantilevers, such as, Lead zirconate titanate (PZT) millimeter-sized, may be configured with two types of anchor asymmetry that induced expression of either torsional or lateral modes in frequency ranges, such as the 0-80 kHz frequency range. Experiments, analytical models, and finite element simulations show that anchor asymmetry may enable resonant mode impedance-coupling. The sensitive torsional and lateral modes may enable measurement of self-assembled monolayer formation rate. The anchor configuration principle may be extended to micro-cantilevers via finite element simulations, which may cause, for example, 97% sensitivity improvement relative to symmetric configurations and created new non-classical resonant mode shapes.

As well as exhibiting resonant frequency change resulting from bending modes, cantilever sensors also may exhibit other types of resonant modes which include torsional, lateral, and longitudinal modes. Torsional, lateral, and/or longitudinal modes may have superior sensitivity for surface molecular binding. This disclosure describes the use of lateral and torsional modes for measuring surface molecular self-assembly in liquid and the associated sensitivities. Both torsional and lateral modes may also enable continuous measurement of self-assembly rate.

One reason why bending modes may have been the choice of most research investigations in biosensing is due to ease of deflection-based measurement by traditional optical transduction principles. However, deflection of torsional and lateral modes is far lower, limiting their measurement optically. Thus, measuring non-bending modes, especially in-plane modes, may require either non-uniform cantilever geometry which may enhance local deflection or non-optical transduction principles. However, optical techniques may be used at a compromised signal-to-noise ratio. Electrically-active piezoelectric materials, such as lead zirconate titanate (PZT), may offer attractive properties as their electrical impedance can be coupled with all resonance modes. They may also offer high sensitivity and continuous measurement capabilities in liquid-phase due to use of high-order modes and macro-scale configuration which may make them attractive relative to many other cantilever sensors which suffer from significant damping in liquid, difficulty integrating into liquid-based applications, and relatively more complex sensing-exciting techniques for resonance. As described herein, impedance-coupling of lateral and torsional modes in PZT cantilevers is not inherent in traditional cantilever configuration. Such impedance-coupling may be achieved via asymmetric anchoring. This approach of anchor configuration may be extended to microcantilever configurations to create exemplary cantilever-based biosensors.

Experiments were conducted utilizing an asymmetrical anchor configuration as described herein. Reagents utilized include phosphate buffered saline (PBS, 10 mM, pH 7.4) was purchased from Sigma-Aldrich (Allentown, Pa.). Deionized water (18 MΩ, Milli-Q system, Millipore). Thiol 6-mercapto-1-hexanol (MCH) was obtained from Fluka (Milwaukee, Wis.). Concentrated sulfuric acid (H₂SO₄) and 30% hydrogen peroxide (H₂O₂) were purchased from Fisher Scientific. 200-proof Ethanol (EtOH) was purchased from Decon Laboratories, Inc. (King of Prussia, Pa.) to assist initial dilution of MCH. The resulting ethanolic solution was then serially diluted to obtain working thiol solutions using PBS.

All sensors (twenty, n=20) were fabricated from lead zirconate titanate (PZT-5A, Piezo Systems, Woburn, Mass.). For in-liquid applications, sensors were electrically-insulated by a polyurethane spin-coat and subsequent chemical vapor-deposited parylene-c layer. Details in coating procedure have been reported previously. For chemisorption experiments, 100 nm of gold (Au) was sputtered over 0.5 mm² area on both sides of the PZT cantilever tip (Desktop DESK IV, Denton Vacuum, Moorestown, N.J.). Prior to thiol adsorption studies, the Au surface was treated with piranha solution for about two minutes (3:1 concentrated H₂SO₄:30% H₂O₂). Caution: Piranha solution is a highly corrosive and strong oxidizing agent and should be handled with care.

The experimental setup utilized an impedance analyzer (Agilent HP4294A), a peristaltic pump, a custom microfluidic flow cell, and fluid reservoirs. For details the reader is referred to previous reports. Prior to an experiment, the entire flow loop was cleaned by rinsing with ethanol and copious amount of deionized (DI) water. In a typical experiment, a sensor was installed in the flow cell and the resonant frequency was allowed to reach steady state at a flow rate of 500 μL/min with recirculating flow. After the resonant frequency reached a constant value, 1 mL of MCH solution (50 μM-100 nM) was introduced to the loop without interrupting the flow by opening the valve to the feed reservoir containing MCH. The resonant frequency was monitored continuously as the MCH solution was continuously recirculated.

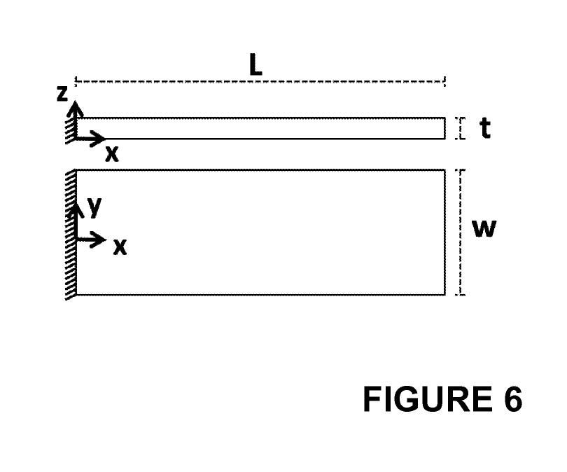

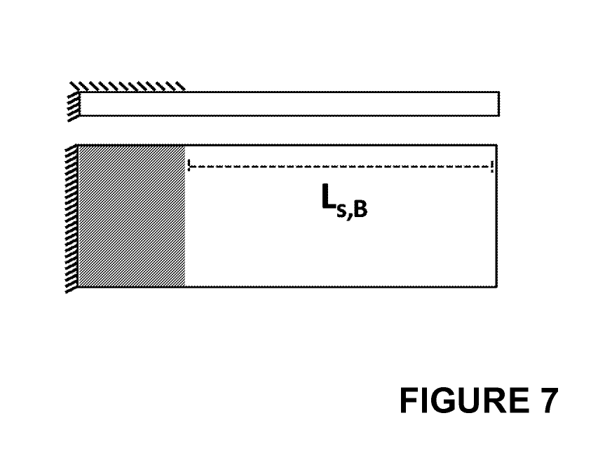

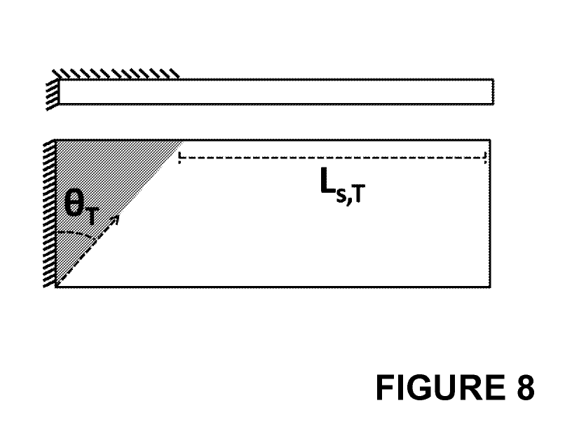

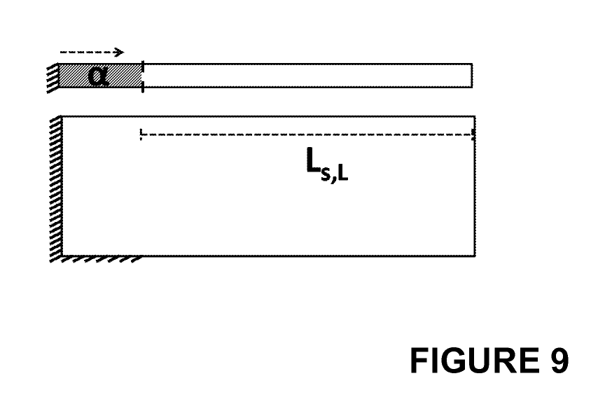

FIG. 6, FIG. 7, FIG. 8, and FIG. 9 depict schematic illustrations of example anchor configurations. FIG. 6 depicts a schematic illustration of a cantilever sensor configuration or an example anchored cantilever structure that has a uniform rectangular geometry (dimensions L-w-t). FIG. 7 depicts an exemplary sensor with length-based asymmetry in the top and bottom faces of the anchored region which has previously been investigated which give rise to bending modes. FIG. 8 depicts an exemplary sensor configuration with anchor asymmetry in the torsional orientation that give rise to torsional resonant modes. FIG. 9 depicts an exemplary sensor configuration with anchor asymmetry in the lateral orientations that give rise to lateral resonant modes. Example anchor configurations described herein modify the anchor on either the top or side of the cantilever thus creating two different lengths on opposite sides, one being equal to the original length (L) and one shortened by the extended anchor (Lₛ).

FIG. 7 and FIG. 9 depict exemplary anchor configurations where the anchor is extended on the top and side of the anchor, respectively. FIG. 8 depicts an exemplary anchor configuration where the length of the anchored region on the top face in the width dimension is modified. In this experiment example, the magnitude of anchor asymmetry of the exemplary anchor configurations, characterized by the ratio α=1−L_{s,L}/L, was varied from 0-0.4 in the present study. The anchor was also modified by varying the length of the anchored region on the top face in the width dimension as shown in FIG. 8. In this experiment example, magnitude of torsional anchor asymmetry in the exemplary anchor configurations, characterized by the angle θ_{T}=arctan [(L−L_{s,T})/w], was varied from 0-45°. The example cantilever configuration depicted in FIG. 8 has an asymmetric anchored domain that induces a torsional angle on the top surface which may be termed as torsional anchor asymmetry. Exemplary cantilever configurations depicted in FIG. 9 has an extended anchored domain on the lateral side that may induce a length-based asymmetry ratio which may be termed as lateral anchor asymmetry. It may be noted that for configurations depicted in FIG. 8 and FIG. 9, θ_{T}=α=0 may correspond to an ideal, or parallel, anchor found in a symmetrically anchored cantilever biosensor that is depicted in FIG. 6.

In an experiment example, symmetrically-anchored and exemplary asymmetrically-anchored PZT cantilevers of thickness (t=127 μm), width (w=1 mm), and of free lengths (L=4 mm; L_{s,L}=L_{s,T}=4−2 5 mm) were modeled using commercially available finite element modeling (FEM) software (COMSOL 3.5a, COMSOL Group, Burlington, Mass.). The expected deformation in PZT at 100 mV excitation is small, and thus, plane-stress assumption was invoked in model development. Zero-deflection boundary condition was imposed on the anchored regions (denoted by hatching and grey-shaded regions in FIG. 7, FIG. 8, and FIG. 9). Electromechanical properties of PZT-5A used for simulation have been reported previously. For PZT cantilever simulations, an electromechanical model enabled coupling of electrical and mechanical effects exhibited by piezoelectric materials. Material damping was modeled by a loss factor (η=0.01) in all frequency response calculations and is fully described in a previous report. The following mechanical properties of silicon microcantilevers were used: density=2,330 kg/m³, Young's modulus=131 GPa, Poisson ratio=0.27. In this experiment example, the total number of tetrahedral elements in each simulation ranged from 389-3,752 and 1,986-8,482 for PZT and silicon models, respectively. Quadratic basis functions were used for constructing elemental displacement fields. Resonant frequencies and mode shapes were obtained as minimizing eigenstates of the cantilever strain-energy functional (π) accomplished by invoking the stationarity of π (i.e. δπ=0). For the symmetric cantilever model, the results from FEM were validated against Euler-Bernoulli Beam Theory which showed resonant frequencies agreed within <2.4% for all modes. The number of elements was increased until the calculated resonance frequencies and phase angles converged within <1% and <0.03% of values obtained using the preceding mesh for PZT cantilever and silicon microcantilever models, respectively. Frequency response was carried out using course mesh (about 300-500 elements) at 10 Hz resolution. Current and charge densities on electrode surfaces were integrated over the electrode area to obtain total current (I) or charge (Q) as a function of excitation frequency. The experimentally measured electrical response output variable, phase angle φ=arctan [−Im(I)/Re(I)], was then calculated.

Table 1 illustrates a summary of FEM calculations in terms of anchor asymmetry effects on charge accumulation mechanism of impedance-coupling and mode shapes. Unmodified cantilever lengths (L) of torsional and lateral anchor asymmetry sensors were 3.2 and 3.7 mm, respectively.

TABLE 1

| | Resonant | | | |
|---|---|---|---|---|
| | frequency, f | | | ΔdQ/df |
| Asymmetry | [kHz] | Q-value | Mode | [pC/kHz] |
| θ_{T} = 0 | 6.4 | n/a | Bending | <0.01 |
| | 35.6 | n/a | Torsional | <0.01 |
| | 39.0 | n/a | Bending | <0.01 |
| | 41.5 | n/a | Lateral | <0.01 |
| θ_{T} = 45° | 9.5 | 106 | Bending | 8.9 |
| | 42.8 | 102 | Torsional | 3.3 |
| | 56.4 | 104 | Torsional-Lateral | 1.7 |
| | 61.8 | 94 | Torsional | 12.6 |
| α = 0 | 4.7 | n/a | Bending | <0.1 |
| | 29.3 | n/a | Bending | <0.1 |
| | 30.8 | n/a | Torsional | <0.1 |
| | 31.7 | n/a | Lateral | <0.1 |
| α = 0.39 | 10.1 | n/a | Bending | <0.1 |
| | 38.4 | n/a | Torsional | <0.1 |
| | 61.7 | 87 | Lateral | 47.1 |
| | 62.6 | n/a | Bending-Torsional | 3.9 |

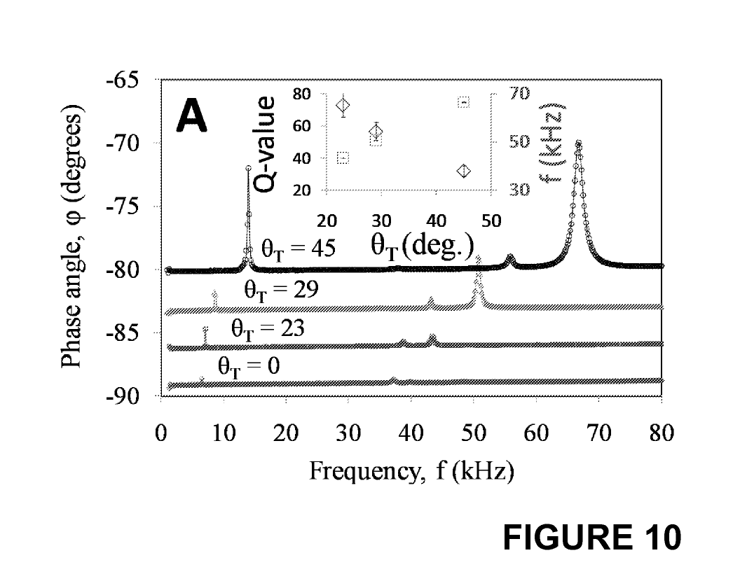

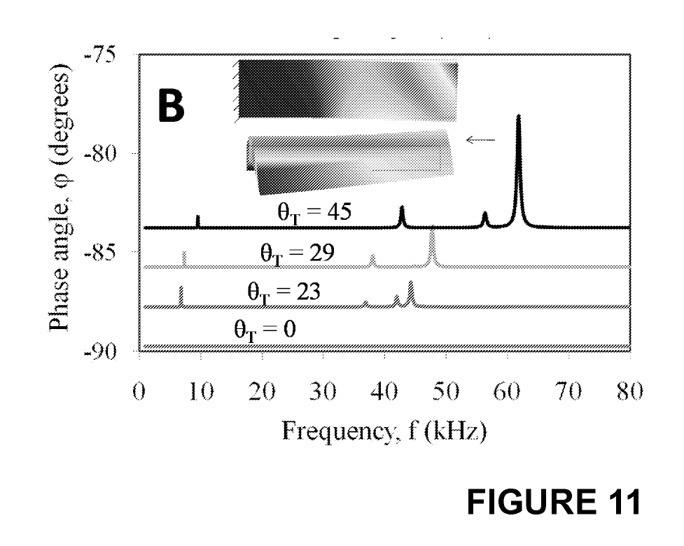

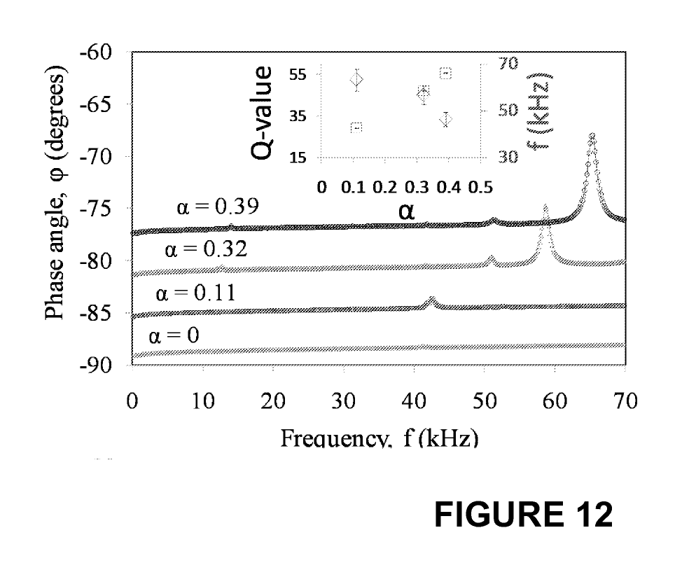

FIG. 10 and FIG. 12 illustrate that when θ_{T}=α=0, cantilever sensors with ideal symmetric anchor as depicted in FIG. 6 did not express any significant electrically-observable resonant modes in the 0-80 kHz range. However, FEM eigen frequency analysis gave four resonant modes over this frequency range (as seen in Table 1). This may suggest that the resonant modes that were present did not couple with impedance changes in PZT. In other words, these modes were not electrically-observable. Likewise, FIG. 11 illustrates that the FEM frequency response analysis of symmetrically anchored PZT sensors did not exhibit measurable-resonance, consistent with experimental measurement. The condition for impedance-coupled resonant modes can be derived by inspection of the following relationship for change in impedance (Z=ΔV/I) given by Equation (3):

$$\frac{d Z}{d \text{?}} = \frac{d}{d \text{?}} ( \frac{Δ V}{\text{?}} ) = Δ V \frac{d}{d f} ( \text{?} ) = Δ V \frac{d}{d f} ( \frac{d t}{d Q} ) = Δ V d t \frac{d ( {Q}^{- 1} )}{d f} \\ \text{?} \text{indicates text missing or illegible when filed} \qquad ( 3 )$$

where f is the frequency, ΔV is the applied voltage, I=dQ/dt is the current, t is the time, Q is the charge, and d is the linear differential operator. Thus, as per Equation (3), for a resonant mode to be impedance-coupled dZ/df must differ from its off-resonance value. As reflected in Equation (3), given ΔV dt is constant with respect to frequency change, impedance-coupling may occur, for example, only if dQ differs at resonance from its off-resonance value. As shown in Table 1, change in accumulated net charge at resonance relative to off-resonance values (Δ(dQ/df)) did not occur to any significant extent. In all calculations, distance of 5 kHz was used as off-resonance value based on average resonant mode Q-values. Selection of a different basis may not change conclusions regarding impedance-coupling, but only the numerical values of Δ(dQ/df).

Length asymmetry as illustrated in FIG. 7 may give rise to measurable bending modes that are mass sensitive to molecular binding. Since both torsional and lateral modes may be useful in sensing, exemplary cantilevers have been configurationed, as described elsewhere in this disclosure, with asymmetric anchor that induce expression of torsional and lateral modes in lieu of bending modes via configurations shown in FIG. 8 and FIG. 9, respectively. Both configurations were examined experimentally and using FEM simulation the effects of successive changes in θ_{T}. FIG. 10 illustrates that modifying the ideal anchor from θ_{T}=0 to θ_{T}=23° may enable four new resonant modes to be measured in the 0-80 kHz range which were absent at θ_{T}=0. FIG. 10 further illustrates that successively increasing θ_{T} may cause successive increase in: (1) magnitude of impedance-coupling, (2) magnitude of resonant frequencies, and (3) separation of adjacent resonant modes. For the case of the highest magnitude of asymmetry examined (θ_{T}=45°), four resonant modes were present at 13.9, 37.2, 55.6, and 66.6 kHz with Q-values of 35, 42, 43, and 39, respectively.

FIG. 11 illustrates that the FEM results for the same θ_{T} values (0, 23°, 29°,45°) agree well with experimental results. For example, modifying the ideal anchor with θ_{T}=23° caused four resonant modes to manifest that were absent at θ_{T}=0. Likewise, as θ_{T} was increased, so did magnitude of impedance-coupling, resonant frequencies, and separation of adjacent modes. For the largest magnitude of asymmetry investigated (θ_{T}=45°), four modes at 9.5, 42.8, 56.4, and 61.8 kHz were present. List of resonant modes is summarized in Table 1, and a detailed discussion on mode shapes is disclosed elsewhere in this disclosure. Inspection of net charge accumulation at resonance for all modes (Table 1), may confirm that the torsional anchor induces significant charge accumulation not found at θ_{T}=0, causing impedance-coupling as per Equation (3). Not only did FEM simulation agree well with experimental measurements qualitatively, but also quantitatively based on resonant frequency and phase angle values which were within 13.3% and 12.7%, respectively. Such agreement may suggest that experimentally observed changes were indeed caused by anchor asymmetry.

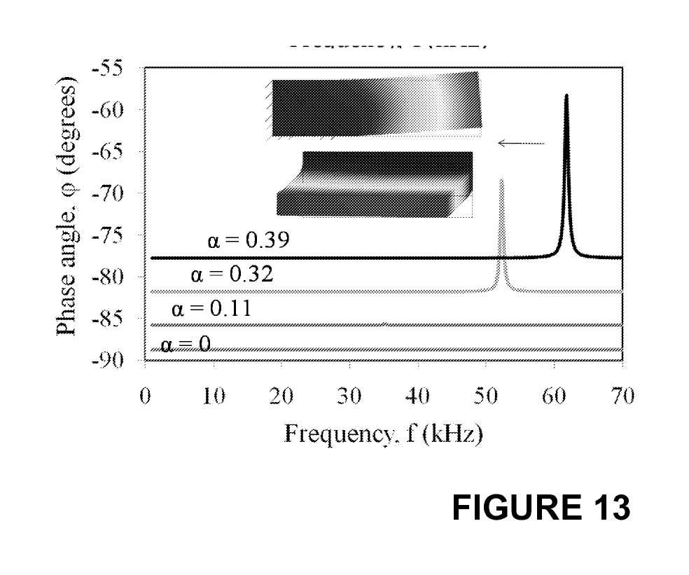

This experiment example examines whether the electrically-observable modes results exhibited in torsional anchor asymmetry, could be achieved using lateral anchor asymmetry (α). FIG. 12 illustrates that introduction of lateral anchor asymmetry (α=0.11) may cause expression of one resonant mode at 42.4 kHz which was absent at α=0. As α was successively increased (0-0.39) both magnitude of impedance-coupling and resonant frequency increased. For the largest magnitude of asymmetry examined (α=0.39), a dominant mode at 65.2 kHz was present with Q=39, in addition to three weakly expressed modes at 13.8, 41.6, and 51.2 kHz. FEM results, shown in FIG. 13, closely reflect the experimental results. For example, modifying the ideal anchor with lateral asymmetry (α=0.11) caused a single resonant mode to manifest at 34.2 kHz with minimal coupling. Likewise, as α was increased (α=0-0.39) so was magnitude of impedance-coupling and resonant frequency. For the largest value of a examined, a single resonant mode was highly expressed at 61.7 kHz (as seen in Table 1). Although three additional modes were found over the 0-70 kHz range (as seen in Table 1), only the mode at 61.7 kHz gave high Δ(dQ/df)=47.1 pC/kHz which is consistent with the presence of only a single dominant mode observed experimentally at 65.2 kHz.

The type of dominant resonant mode may differ depending upon anchor asymmetry. For example, increasing the magnitude of anchor asymmetry in both torsional and lateral anchor configurations may cause increase in impedance-coupling and resonant frequency values, and may also cause different characteristic spectra. Specifically, not only did number of modes actuated differ, but so did magnitude of impedance-coupling. As shown in Table 1, torsional asymmetry coupled a greater number of modes to impedance change, but lateral asymmetry led to stronger impedance-coupling of modes as indicated by higher Δ(dQ/df) values. This may suggest that the nature of the resonant modes that became actuated were inherently different and depended on the type of asymmetry used. To further elucidate these notable differences, the resulting mode shapes in each configuration were examined, descriptions of which are included in Table 1.

FIG. 11 and FIG. 13 contain insets showing both the top- and front-views of the mode shape expressed in the dominant mode of each configuration. For the case of torsional asymmetry, the dominant resonant mode comprised out-of-plane torsional motion. Analysis of the other smaller phase angle modes may reveal that they also had torsional character, which in the third mode, was present in combination with lateral motion. For the case of lateral asymmetry, the dominant resonant mode exhibited only in-plane lateral character. Analysis of mode shapes suggests that although both anchor asymmetries enabled resonance-coupling to impedance changes, different types of modes are coupled. Such modes have not yet been investigated for measuring surface molecular binding in the literature which is important in their use as biosensors.

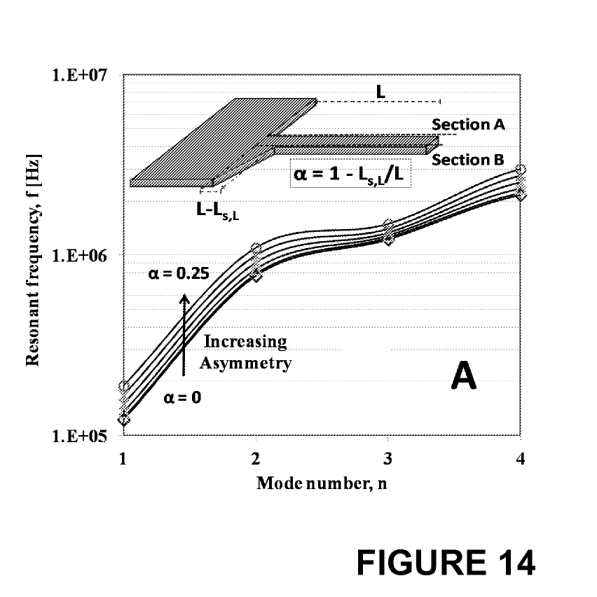

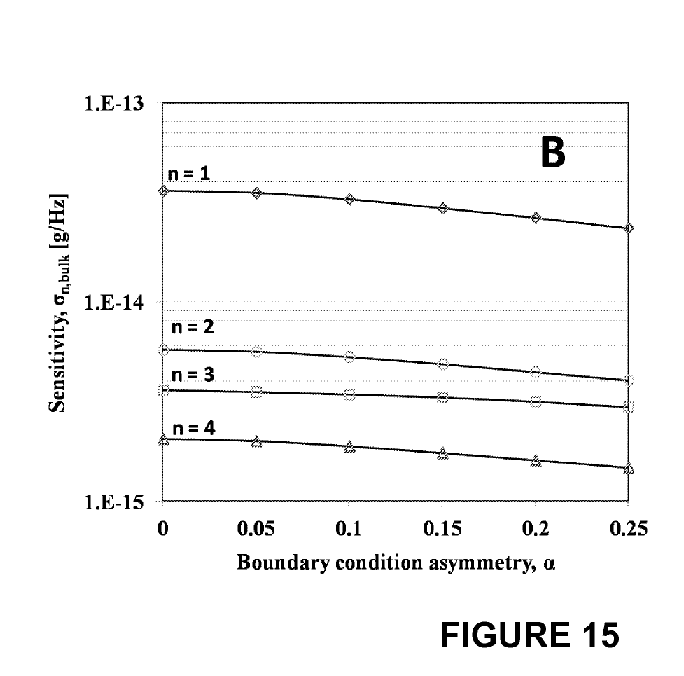

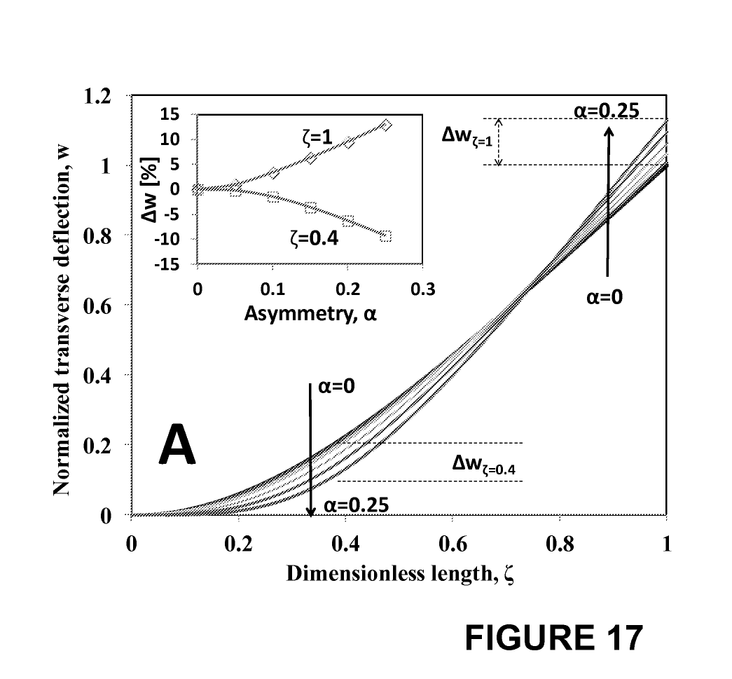

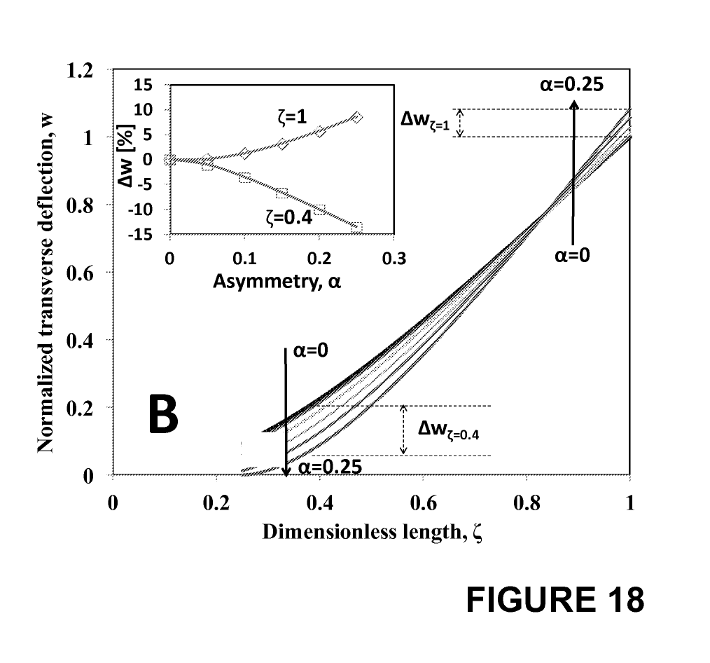

In this experiment example, prior to examining their liquid phase sensing characteristics, it was examined if anchor asymmetry can also impart new and improved characteristics to microcantilevers, as they are extensively used in sensing. FIG. 14 illustrates effect of asymmetry on resonant frequency of the first four modes in a silicon microcantilever for successively increasing asymmetry parameter α=0, 0.05, 0.1, 0.15, 0.2, 0.25. FIG. 15 illustrates effect of asymmetry on cantilever sensitivity for the first four resonant modes showing sensitivity increase caused by asymmetry. FIG. 17 and FIG. 18 illustrate the effect of asymmetry on the transverse deflection profiles relative to symmetric cantilever deflection. FIG. 17 further illustrates the deflection profile corresponding to the unmodified side of the cantilever designated as section A in FIG. 14. FIG. 18 further illustrates the deflection profile corresponding to the modified side of the cantilever designated as section B in FIG. 14. As illustrated in FIG. 14, lateral asymmetry is examined given the ease of fabricating such asymmetry by traditional microfabrication techniques and since it may already arise inherently in micro- and nanocantilevers to a small extent due to unavoidable fabrication imperfections. Thus, ELM models of silicon microcantilevers (L·w·t=100·10·1 μm³) were constructed to examine effects of lateral anchor asymmetry on microcantilever properties. It was found that even though the microcantilevers differed in terms of material, size, and method of introducing the anchor asymmetry, the effects of lateral anchor asymmetry were similar to those we observed in PZT millimeter-sized cantilevers. Detailed analyses of results are illustrated elsewhere in this disclosure.

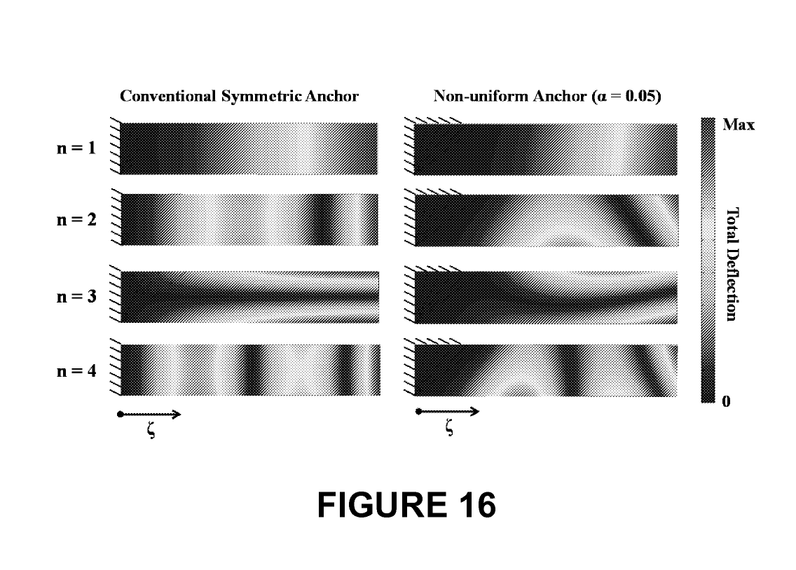

FIG. 16 illustrates the effect of non-uniform anchor on mode shape (top-view) shown for the case of 5% asymmetry in the constrained boundary (α=0.05). Hatching denotes a constrained surface over which zero-deflection boundary conditions are applied. As illustrated in FIG. 16, lateral anchor asymmetry may cause changes in mode shapes. As seen in FIG. 14, FIG. 15, FIG. 17, and FIG. 18, data also may suggest that lateral asymmetry can be used to increase sensitivity of microcantilever sensors by 97% due to combined effects of increase in resonant frequency and deflection characteristics. FIG. 17 and FIG. 18 further illustrate that the ability to tune local deflection profiles has high potential for affecting new applied techniques, such as determination of node locations in non-uniform cantilevers and bianalyte sensing on a single cantilever. Based on such interesting effects, the aspect of sensitivity was further examined in the PZT millimeter-cantilever sensors.

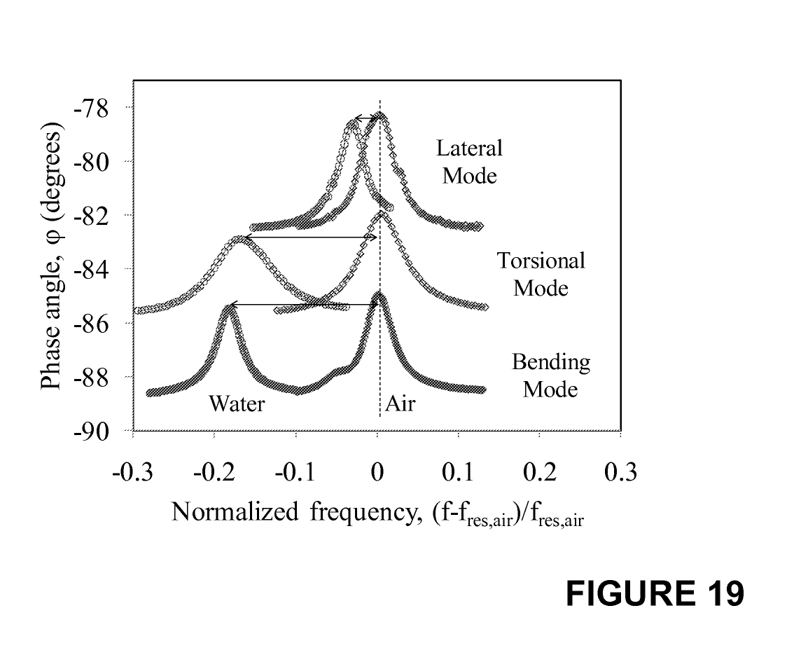

An experiment was conducted to determine if torsional and lateral modes may be sensitive to molecular binding. In this experiment example, it was of interest to determine if the torsional and lateral modes are sensitive to mass-change caused by surface binding of molecules. The dominant mode expressed was investigated in both configurations for sensing. Sensors with highest magnitude of anchor asymmetry examined were used. FIG. 19 illustrates the experimentally measured frequency spectra of both sensor configurations in air and liquid.

As illustrated in FIG. 19, the torsional mode exhibited larger shift in frequency and Q-value upon immersion in liquid (Δf_{air-liquid}=4.1 kHz, Qₐᵢᵣ=23.3, ΔQ_{air-liquid}=9.5) than did the lateral mode (Δf_{air-liquid}=1.5 kHz, Qₐᵢᵣ=37.4, ΔQ_{air-liquid}=6.4), which may suggest that the fluid-structure interaction differs depending on the resonant mode shape. One explanation of these effects could be due to the greater amount of fluid which is displaced by the out-of-plane torsional mode as it vibrates, and thus greater added-mass effect, relative to the amount of fluid displaced by the in-plane lateral mode. Examination of the associated cantilever Reynolds number (Re_{c}=ρfL_{char}²/4μ, where the characteristic length (L_{char}) is the cantilever width for the torsional mode and the thickness for the lateral mode, may reveal the torsional mode is less damped in liquid than the lateral mode due to quadratic dependency of the L_{char} term (Re_{c}=5,270 and 190, respectively, based on resonant frequency in liquid of 19.0 and 42.8 kHz, respectively).

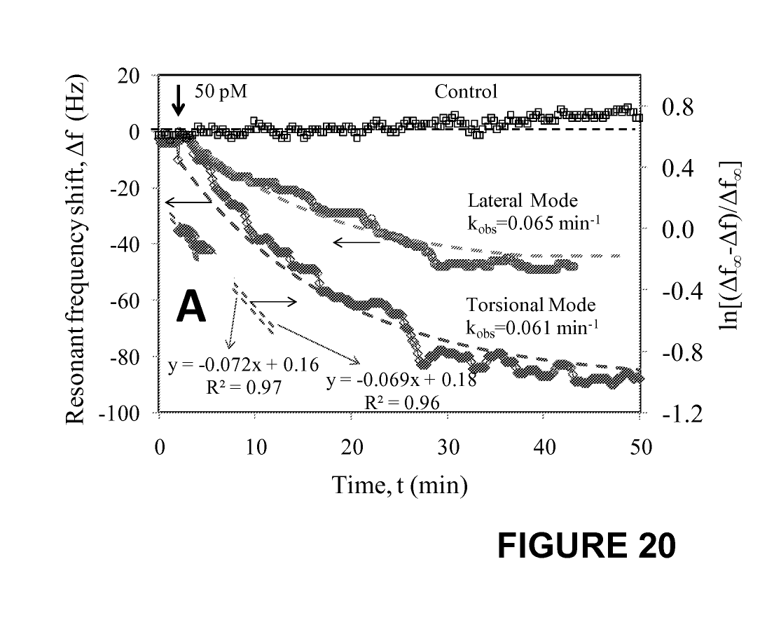

After examining the air-liquid sensor properties, the electrically-insulated cantilever sensors with 1 mm² gold sensing area for facilitating thiol chemisorption were installed in a flow cell, thus positioning the sensor directly in a flowing stream of pure buffer. After resonant frequency reached a steady-state in flowing pure bufferone mL of dilute MCH (50 pM) prepared in the same buffer was introduced to the flow loop in recirculation mode. FIG. 20 illustrates resonant frequency of both modes decreased exponentially over a 35 minute period due to mass increase caused by MCH binding to sensor gold surface. Ultimately, in both cases, the resonant frequency reached a new steady state due to binding equilibrium resulting in a net decrease in the resonant frequency of 89 and 49 Hz for torsional and lateral modes, respectively. Switching the flow back to pure buffer caused no further change in the resonant frequency, which may indicate that the shift was entirely due to added-mass and not due to fluid effects. Given one mL of 50 pM MCH contains 50 fmol or 6.7 pg, the mass-change sensitivity can be estimated at 75 and 135 fg/Hz, respectively, based on the measured net frequency shifts and the assumption that all mass introduced binds. It may be noted that complete binding is unlikely; however, it provides a conservative estimate of each mode's mass-change sensitivity.

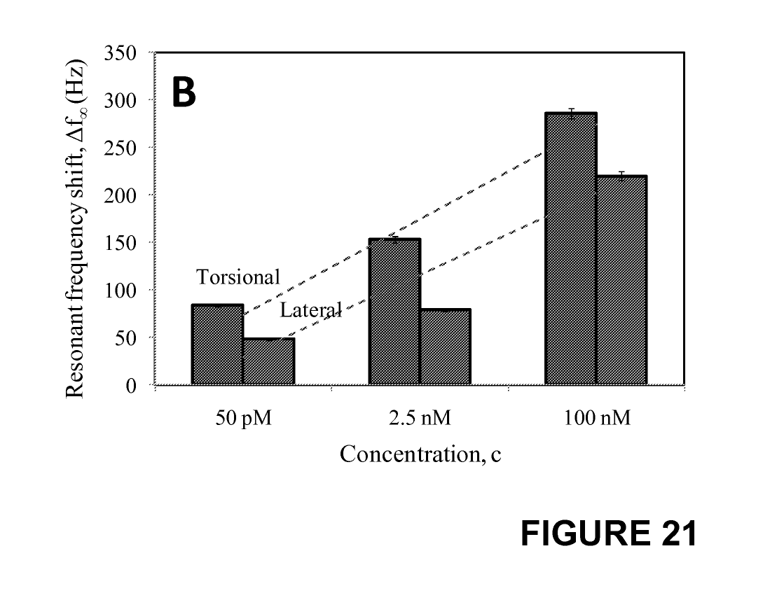

As illustrated in FIG. 21, concentration-dependent binding response of each mode was then measured which showed that torsional modes were also slightly more sensitive than lateral modes at higher analyte binding concentration. Previous studies carried out on bending modes showed mass-change sensitivity of about 400 fg/Hz. Thus, this experiment example may suggest that torsional and lateral modes are complements or even alternatives to bending modes. Torsional modes may appear to be slightly more sensitive than lateral modes.

An experiment was conducted to investigate the effects of different types of resonance vibration on assembly rates. In this experiment example, given the differences in sensitivity between the two resonant modes, the binding rates due to the two different vibration characteristics were examined. This may be important because the molecular self-assembly measured on resonant-mode cantilever sensors does not involve molecular binding to a static surface, as it commonly occurs in many other sensor platforms (e.g. microarray, ELISA), but on a vibrating surface. Surface binding has been suggested to affect the thermodynamics of molecular adsorption.

In this experiment example, mass transfer limitations of the sensor were first examined to determine if the sensor response rate was limited by mass transfer or corresponded to the rate of surface molecular binding phenomena. Given the external flow field conditions (Q=500 μL min⁻¹, Dᵢₙₗₑₜ=1.14 mm, ρ=1,008 kg/m³, μ=9E−04 Pa s, L=1 mm), the associated Reynolds number (Re_{L}=ρvL/μ) was about 2.3. Assuming MCH has a molecular diffusivity of 1E−06 cm²s⁻¹, the ratio of momentum to mass diffusivity, the Schmidt number (Sc=μ/[ρD]), was 8,930. Thus, approximating the physical situation as laminar flow across a flat plate (L=1 mm) the dimensionless mass flux to the sensor, the Sherwood number (Shₘ=kₘL/D=0.664Re_{L}^{1/2}Sc^{1/3})²⁸, was 2,260, indicating convective mass transfer effects are reasonably rapid. In the experiment example, mass transport-limits are determined post-kinetic analysis by comparing measured binding rates with expected rates based on the film mass transfer coefficient (kₘ=2.3E−04 m s⁻¹) calculated from Sh.

The sensor measured binding rate was analyzed using the second-order reversible Langmuir adsorption model given by Equation (4):

$$\frac{Δ f}{Δ {f}_{∞}} = ⌊ 1 - exp ( - ( {k}_{a} c + {k}_{d} ) t ) ⌋ \qquad ( 4 )$$

where kₐc+k_{d}=k_{obs} is the observable rate constant. As shown in FIG. 20, the rate constants observed for self-assembly on the torsional and lateral mode were very similar (k_{obs}=0.061 and 0.065 min⁻¹, respectively). Analysis of the initial binding rate period over the first five minutes, gave slightly higher values of kᵢₙᵢₜ=0.069 and 0.072 min⁻¹, respectively. Assuming mass transfer was limiting binding, the associated rate would be kₘ/L about 13 min⁻¹. However, since kᵢₙᵢₜ about k_{obs}<<kₘ/L, the measured rates may be limited by the binding reaction and not mass transfer, the cantilever-measured binding response may be directly associated with rate of SAM assembly. The reaction kinetics and mass transfer analyses may indicate that regardless of the type of resonant mode used in sensing, the rate of the self-assembly process is not affected.

The current experiment examples showed torsional and lateral modes can be highly sensitive to molecular binding under fully submerged conditions, a characteristic essential for biosensing. It also expanded fundamental insight into relationship between anchor asymmetry and charge accumulation mechanisms in piezoelectric cantilevers. The technique of anchor asymmetry may expand options for making new cantilever sensors by incorporating newly constrained areas at the base, as alternatives and complements to modification of cantilever size and geometry. It may also be seen that the fundamental rate parameters extracted from self-assembled monolayer formation are unaffected by the use of different resonant modes used to obtain them. Sensitivity to molecular assembly in liquid may suggest that torsional and lateral modes have promise in future analytical biosensing applications.

Asymmetric cantilever anchor configuration may be applicable to microcantilevers. FIG. 14 illustrates the effect of asymmetry in the anchor configuration on the resonant frequencies of the first four modes. As the level of asymmetry increased (α=0−0.25), the resonant frequency of all modes also successively increased, although not all to the same degree. For α=0.25, the resonant frequencies increased by 54%, 43%, 22%, and 39%, respectively. This difference is due to the fact that the four resonant modes do not have the same mode shapes. For example, the first (n=1), second (n=2), and fourth modes (n=4) are transverse modes, while the third mode (n=3) is a torsional mode. Given the metric for determining cantilever sensitivity (σ_{n,bulk}) suggests realizable sensitivity is proportional to the ratio of cantilever mass (m_{c}) and resonant frequency (fₙ), given by Equation (5):

$$\text{?} - \frac{Δ m}{Δ {f}_{n}} ∝ \frac{\text{?}}{{f}_{n}} \\ \text{?} \text{indicates text missing or illegible when filed} \qquad ( 5 )$$

where Δfₙ is the resonant frequency shift caused by an added-mass (Δm) Thus, as per Equation (5), the sensitivity of each mode likewise successively increased with inclusion of lateral anchor asymmetry as summarized in FIG. 15. The analysis shows that sensitivity of microcantilevers can be enhanced by as much as 54% based only on the resonant frequency increase that arises from non-uniform anchoring. Thus, this suggests inclusion of lateral asymmetry could be a useful method for further improving sensitivity in smaller cantilevers based on corresponding resonant frequency increase.

As shown in PZT cantilevers, not only did lateral asymmetry increase resonant frequency, but it also caused changes in mode shape. FIG. 16 illustrates top-view comparing the modes shapes that arise in the symmetric cantilever configuration versus those in a cantilever modified with small level of lateral anchor asymmetry (α=0.05) for the first four modes. As seen in FIG. 16, the results show that the non-uniform anchor eliminates the x=0 symmetry plane in the mode shapes and causes concentration of the deflection towards the edges. This may be an important effect since in addition to sensitivity increase based on frequency and mass as per Equation (5), sensitivity can also be interpreted from a localized perspective by the following relation as given by Equation (6):

$$\text{?} ∝ {w}_{n}^{2} ( x ) \frac{{f}_{n}}{{m}_{n , eff}} \\ \text{?} \text{indicates text missing or illegible when filed} \qquad ( 6 )$$

where wₙ(x) is the length-dependent normalized transverse deflection of the n^{th} mode, and m_{n,eff} is the effective mass=ρ_{c}Lwt/4. Such is an important observation since Equation (6) may suggest the modified deflection profiles may correlate with increased sensitivity if they enhance deflection relative to the symmetric configuration. In FIG. 17 and FIG. 18, the effects of the non-uniform anchor configuration on the local transverse deflection profiles are given in terms of the normalized transverse deflection (w) in the fundamental mode along the sections A and B depicted in FIG. 14.

All deflection profiles are normalized to the tip-deflection of the uniformly anchored microcantilever. The notation Δw_{ζ} is used to denote the percent change in deflection caused by anchor asymmetry at the dimensionless length position ζ=x/L. As shown in FIG. 17, the tip-deflection increased by 13% at α=0.25 along section A. The increased tip-deflection may be explained by the requirement of the conservation of strain energy. Examination of the deflection profiles at ζ=0.4 accounts for the required reduction in energy that must accompany the increase in strain energy at the tip. As shown in FIG. 18, similar characteristics are observed on the opposite side of the microcantilever (section B) which is the side that contains the extended anchor domain. However, tip-deflection increased by 8% instead of 13%. Thus, as per Equation (5) and Equation (6), FEM simulations may suggest that lateral asymmetry can be used to increase sensitivity by 97% based on combination of increase in resonant frequency and deflection. The ability to tune local deflection profiles may have high potential for affecting new applied techniques, such as determination of node locations in non-uniform cantilevers and bianalyte sensing on a single cantilever.

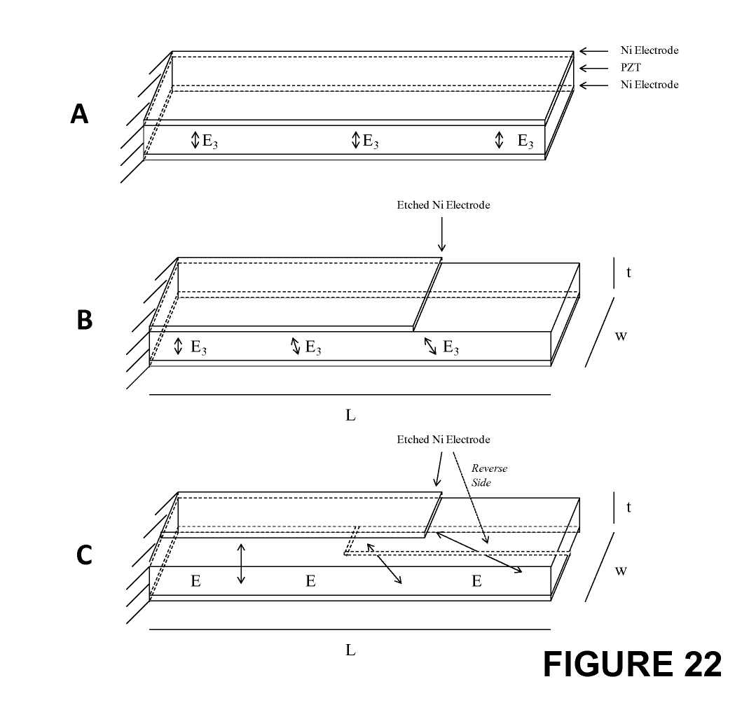

FIG. 22A, FIG. 22B, and FIG. 22C illustrate various examples of positionally-dependent electrode asymmetries. FIG. 22A, FIG. 22B, and FIG. 22C further illustrate asymmetry in exciting-sensing electrode configuration for enhanced actuation. FIG. 22A illustrates an example symmetric configuration. FIG. 22B illustrates an asymmetric electrode configuration with asymmetry in the length of the top and bottom exciting Ni electrodes which have previously been treated that expresses bending modes. FIG. 22C illustrates a proposed configuration with electrode asymmetry in both length and width dimensions for expression of both bending and torsional modes.

FIG. 23A, FIG. 23B, and FIG. 23C illustrate various examples of asymmetry in the mass-binding region whereby added-mass to the resonating structure acts. Note, gold from tip and sides of cantilever are eliminated for clarity of presentation. FIG. 23A, FIG. 23B, and FIG. 23C further illustrate asymmetry in mass-binding region in Au-based sensing applications for enhanced sensitivity. FIG. 23A illustrates a sensor with symmetrically deposited Au on both sides of the sensor tip. FIG. 23B illustrates a sensor configuration with a larger sensing area on one side of the sensor causing an asymmetry in the added mass which binds to the deposited Au along the length. FIG. 23C illustrates a sensor configuration with area that also varies in the width dimension in addition to asymmetric lengths of Au. The configurations illustrated in FIG. 23A, FIG. 23B, and FIG. 23C can also be examined in terms of only a single coated side of the sensor for sensing purposes which may then contain the types of asymmetry shown in FIG. 23C.

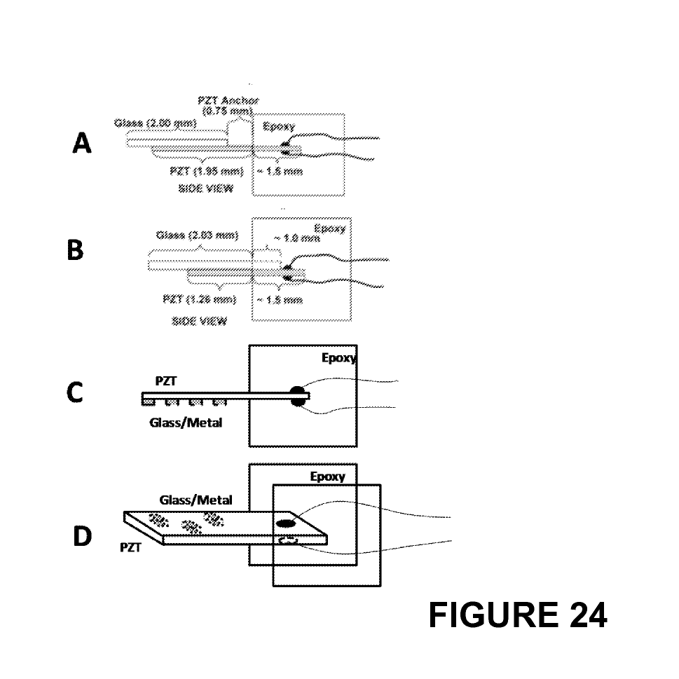

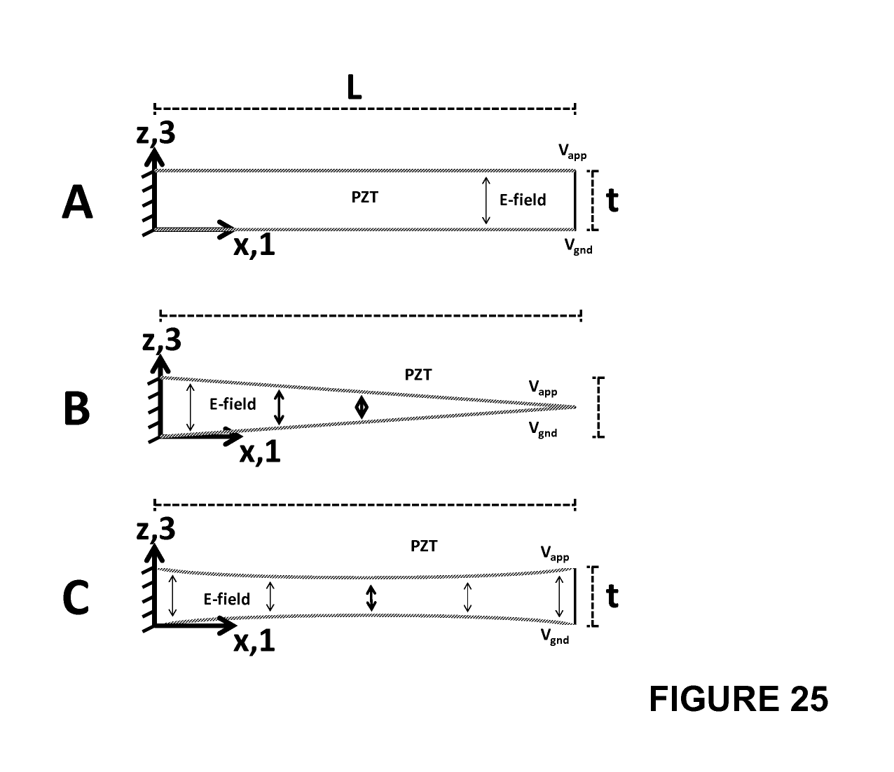

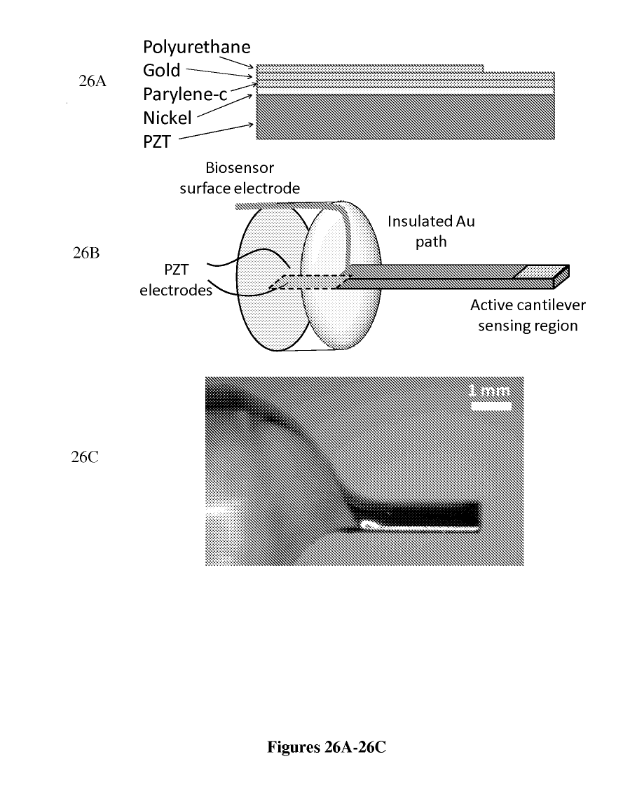

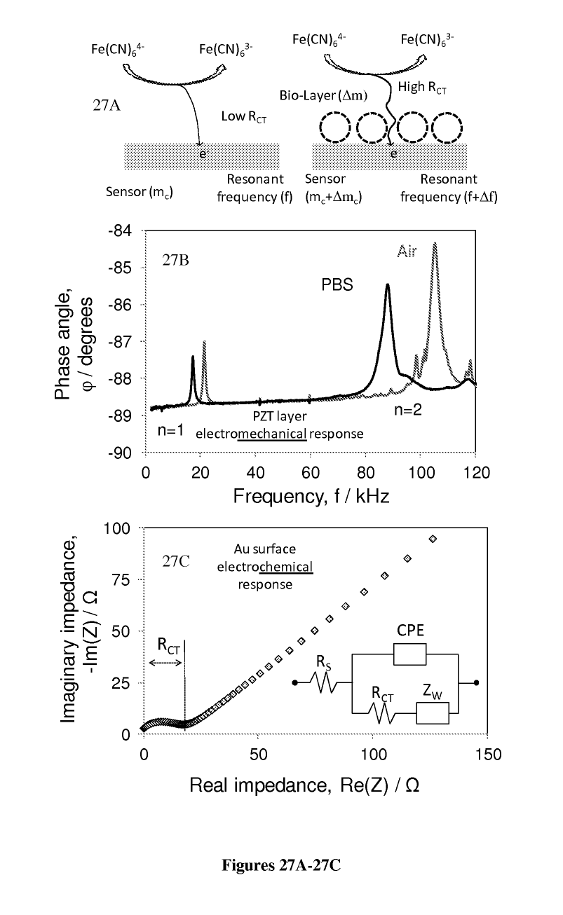

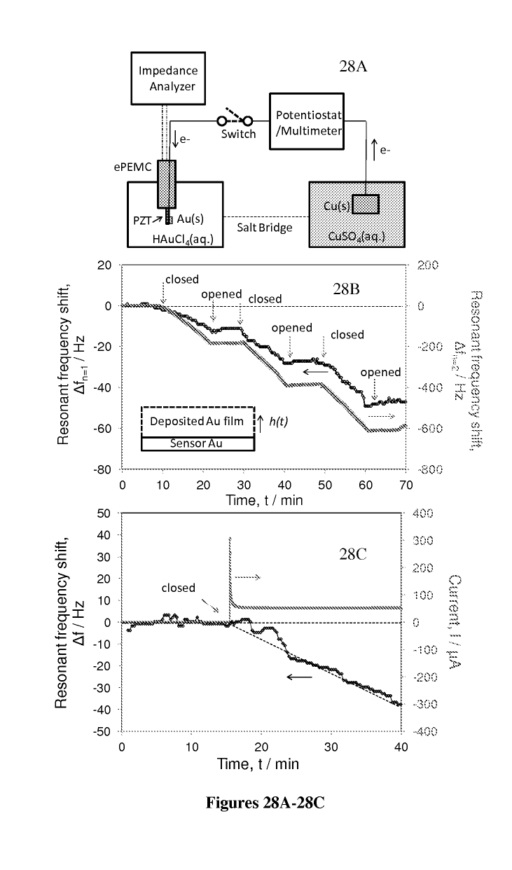

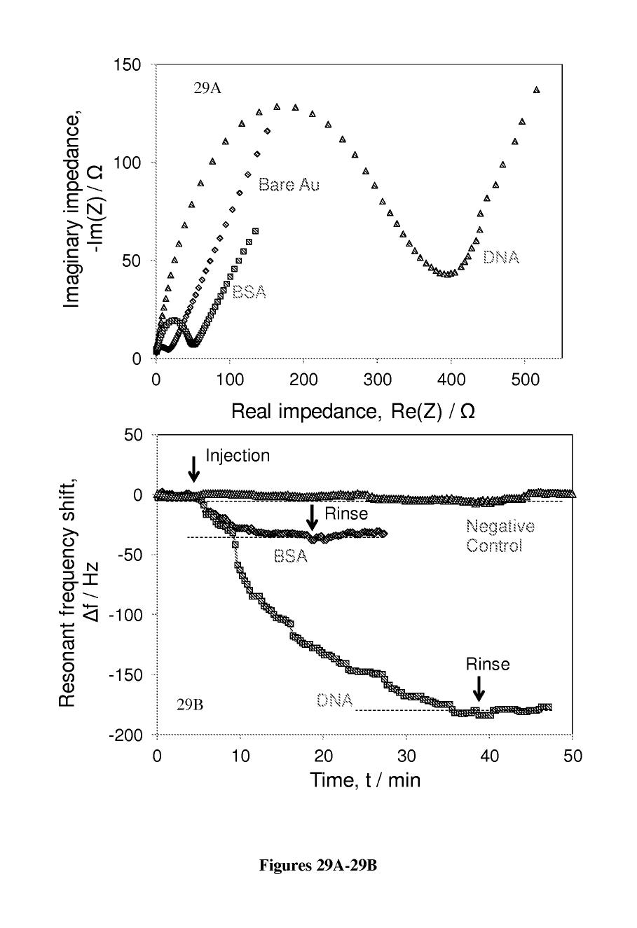

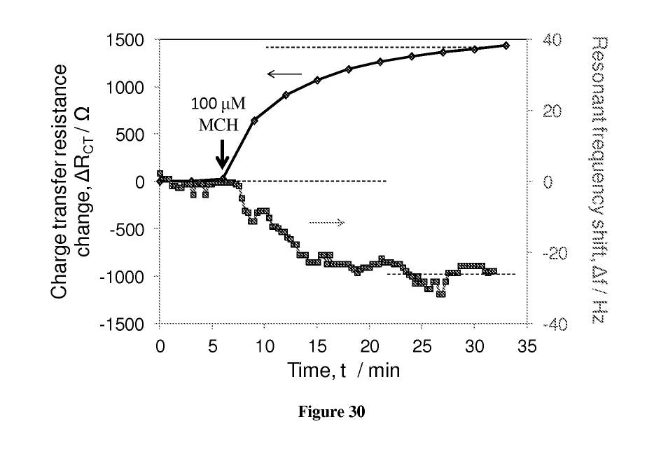

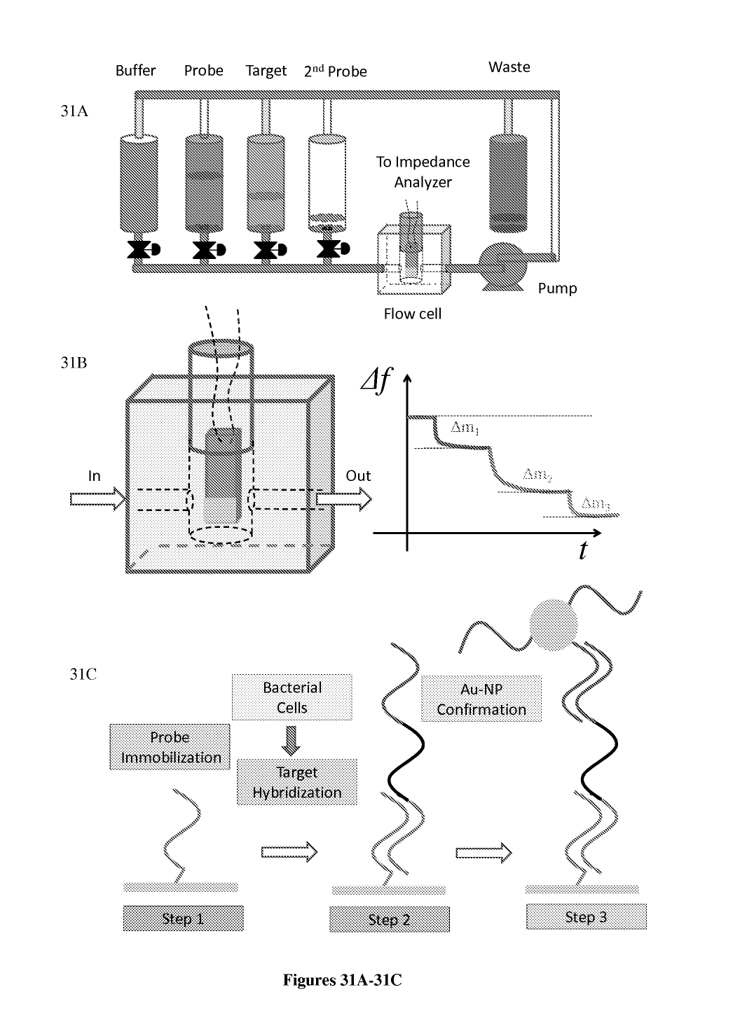

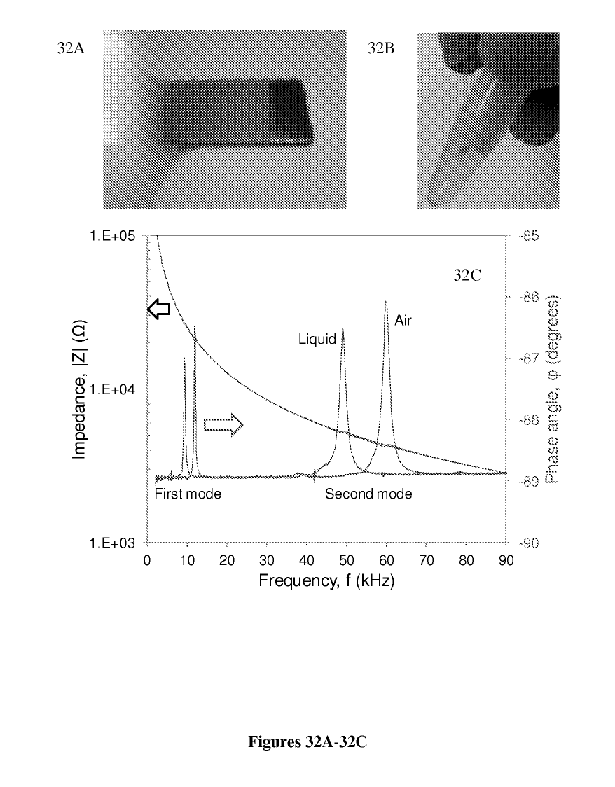

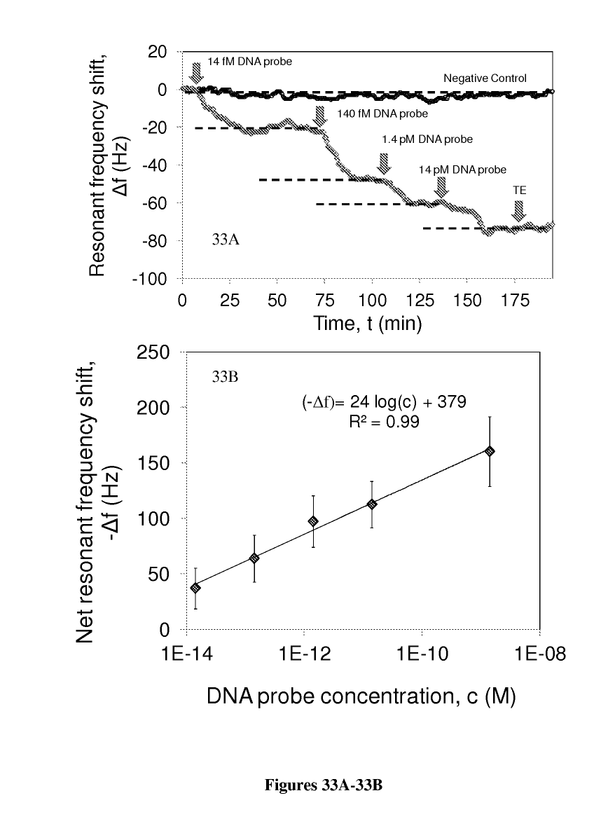

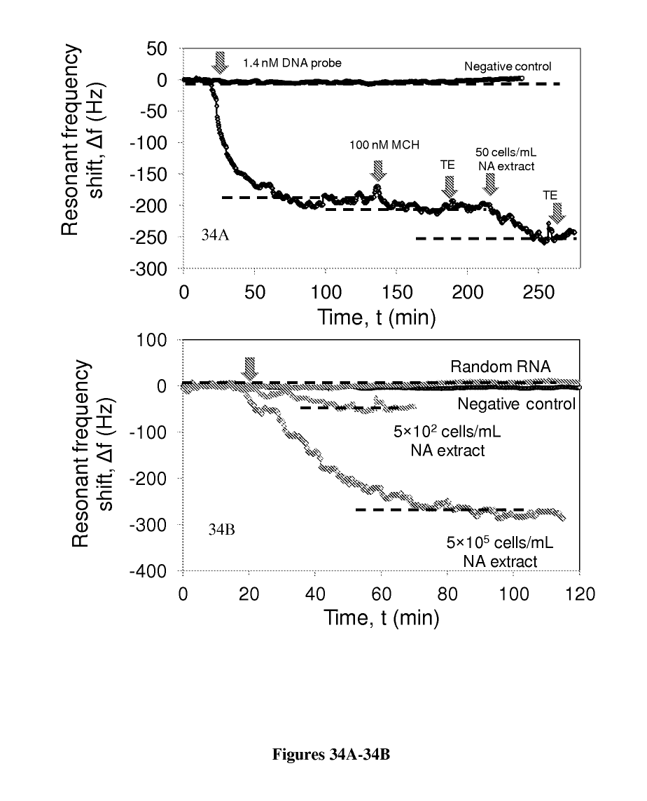

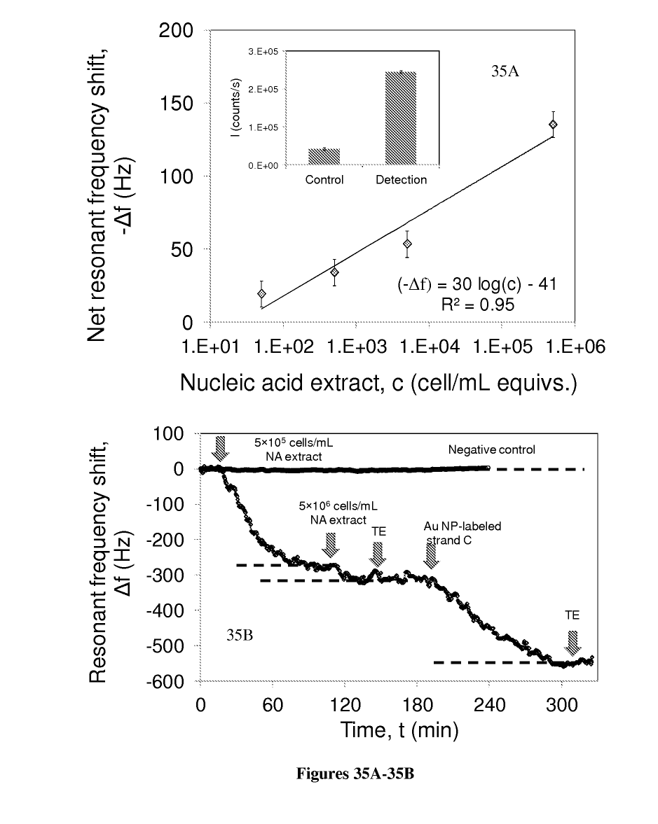

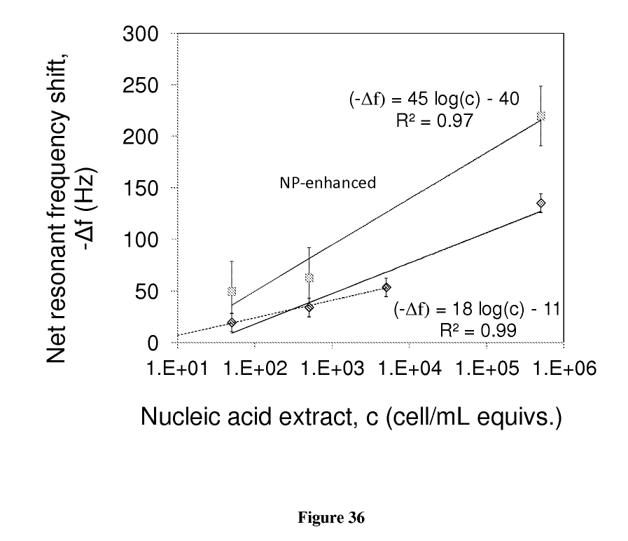

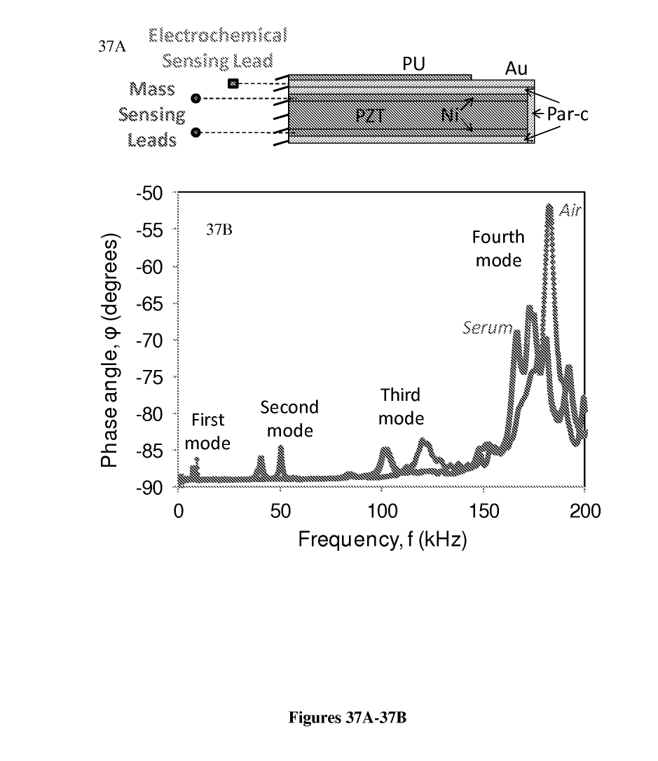

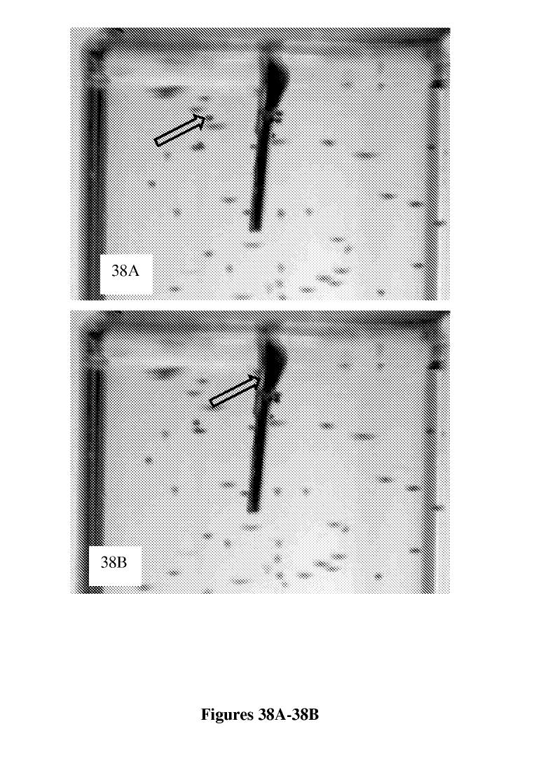

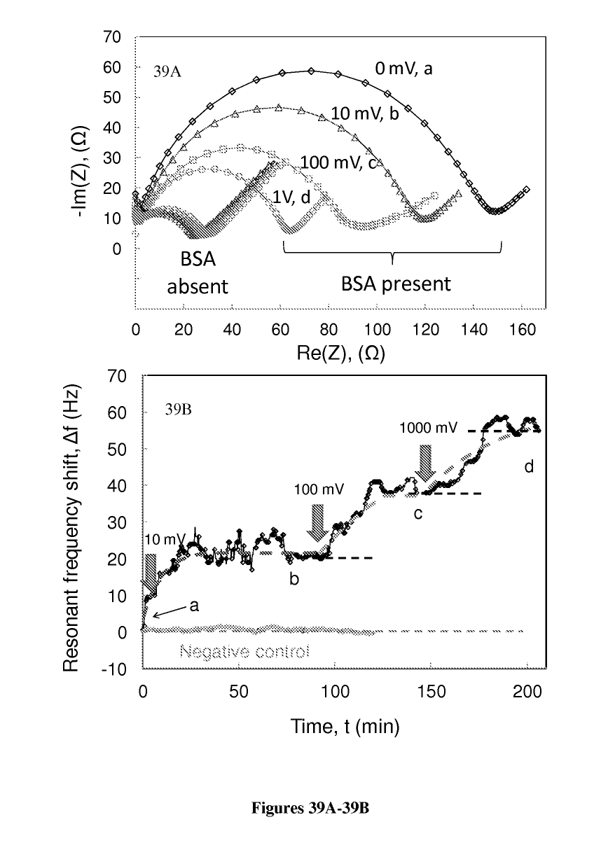

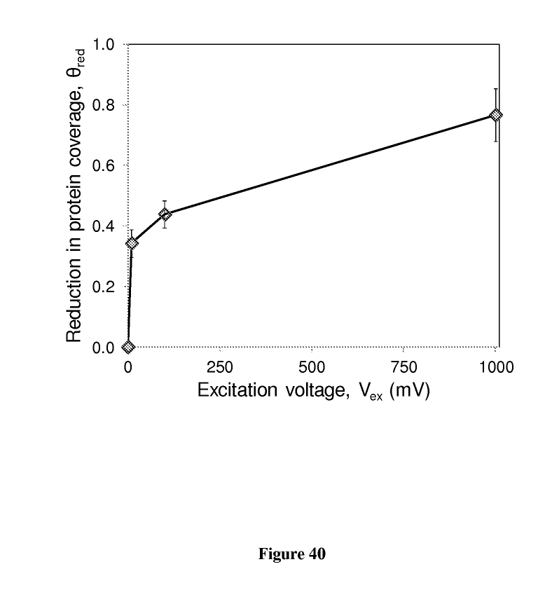

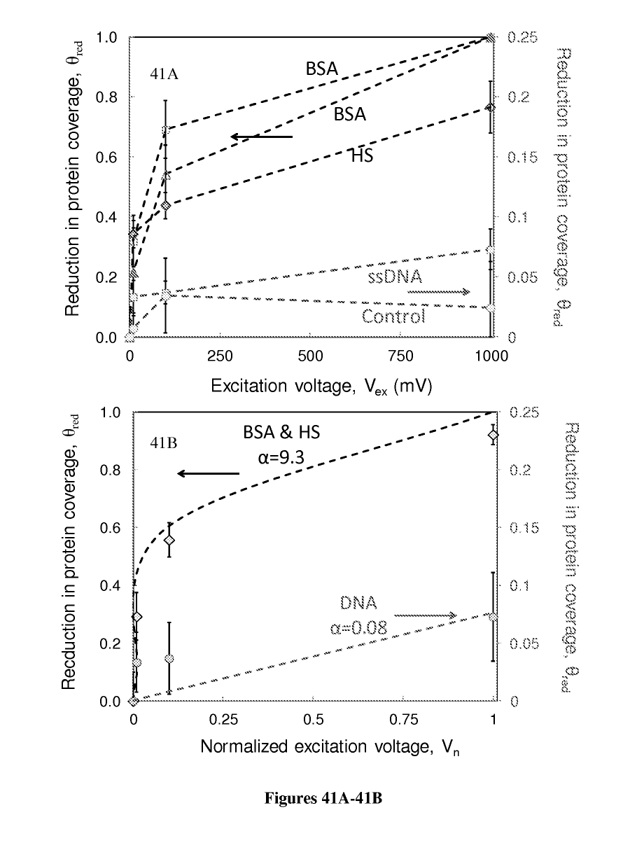

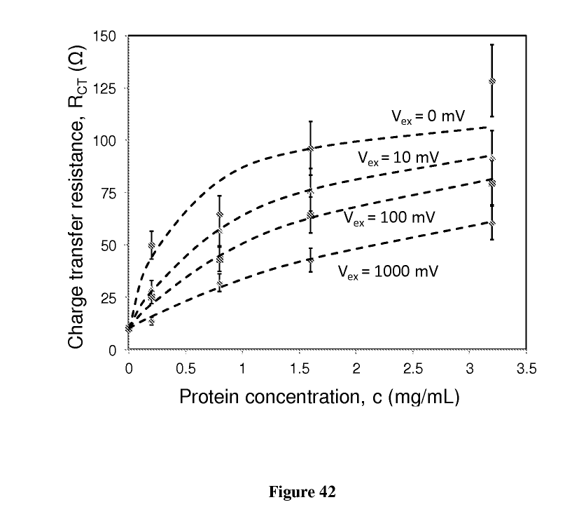

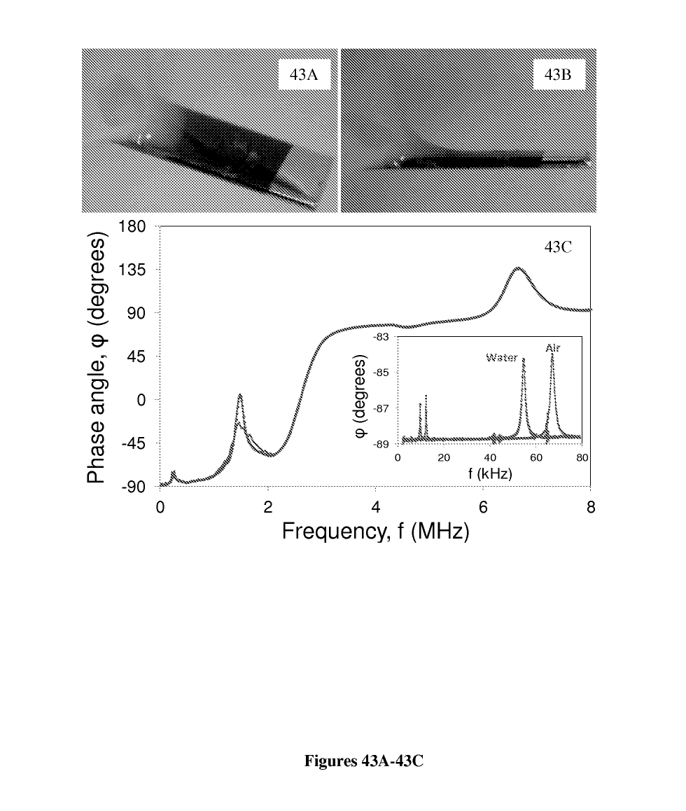

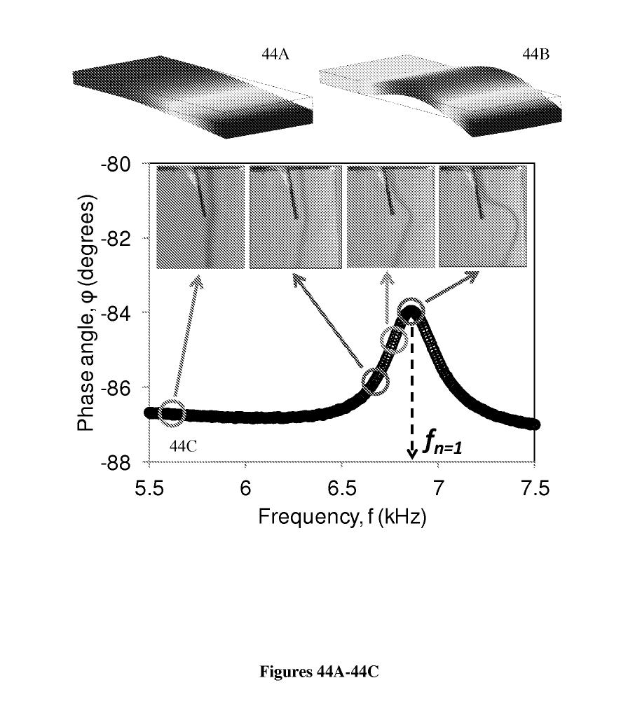

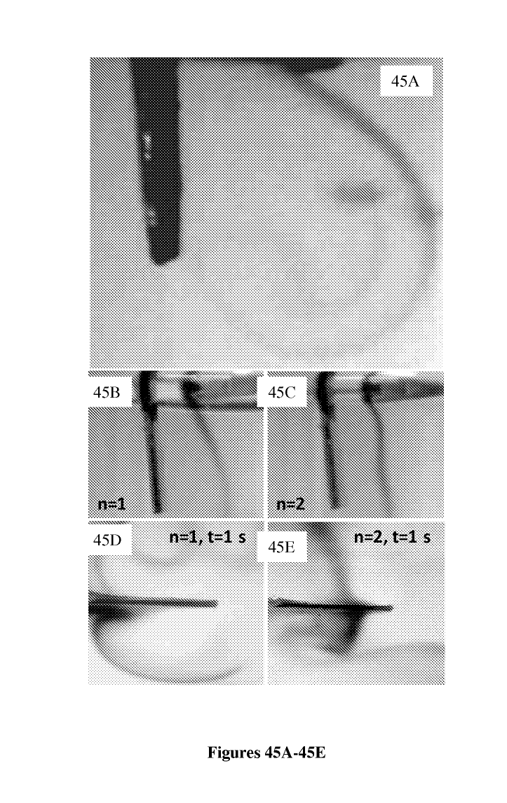

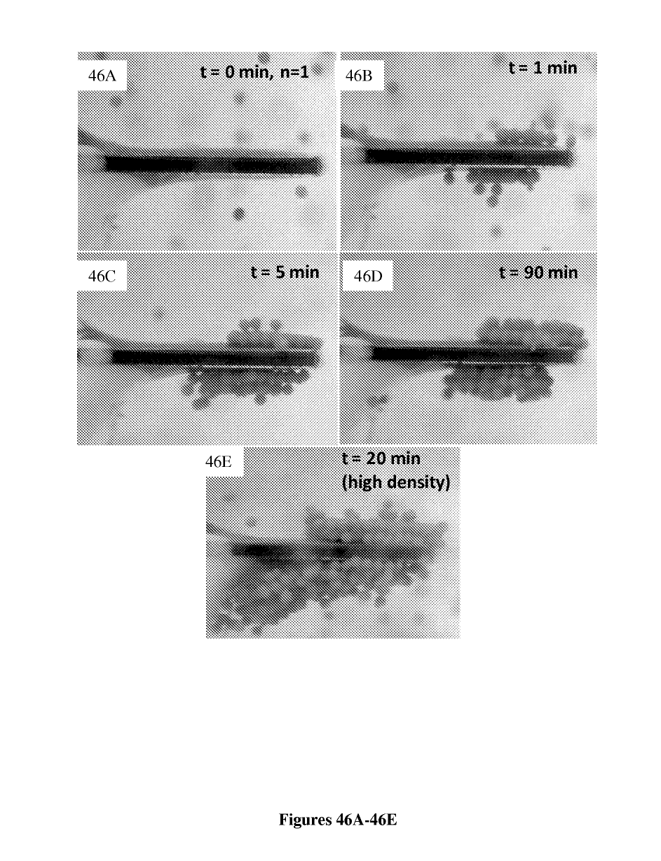

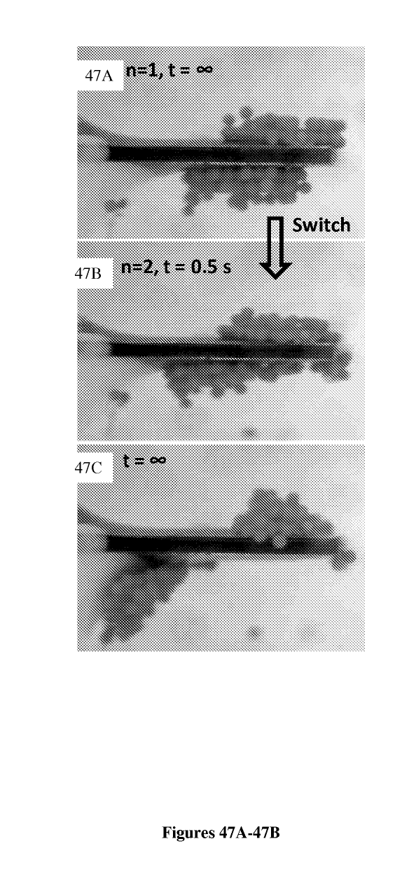

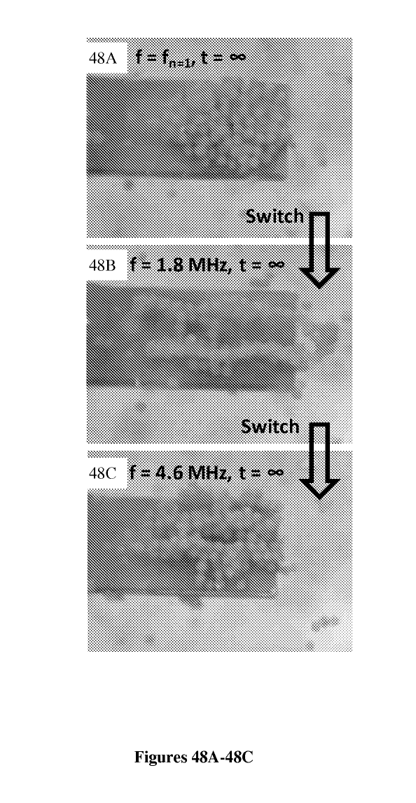

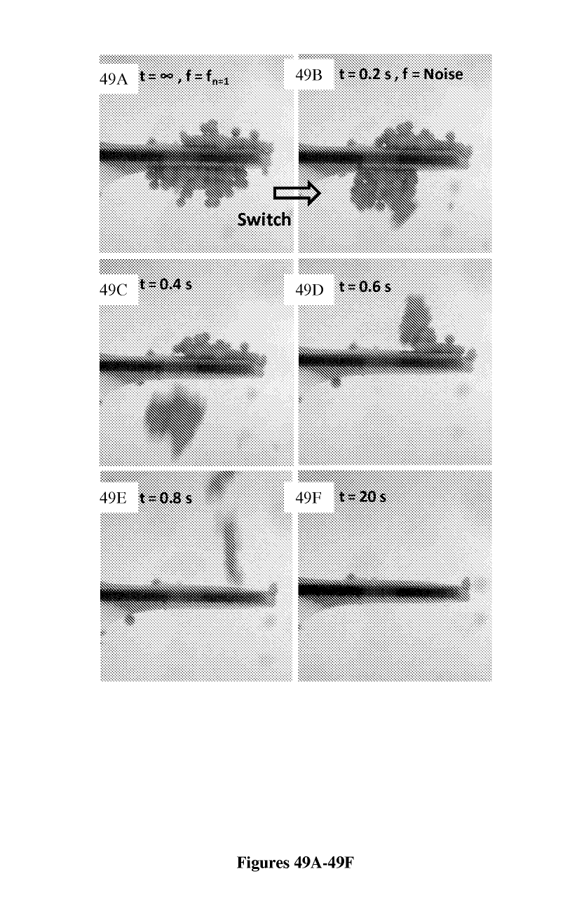

FIG. 24A, FIG. 24B, FIG. 24C, and FIG. 24D illustrate various configurations involving different geometrical combinations of high modulus material (glass/metal) with PZT by bonding to create positionally-dependent asymmetry in bending modulus of the cantilever. FIG. 24A, FIG. 24B, FIG. 24C, and FIG. 24D further illustrate asymmetry in bending modulus (stiffness) for enhanced actuation. FIG. 24A and FIG. 24B illustrate sensor configurations which involve bonding over various different lengths. FIG. 24C and FIG. 24D illustrate exemplary sensor configurations which extend the idea to bonding the high modulus material at point-wise positionally-dependent locations. The number of points used may also be used as a configuration parameter to facilitate actuation of various desired resonant modes.

FIG. 25A, FIG. 25B, and FIG. 25C illustrate various types of asymmetry in thickness dimension of the cantilever sensor which causes variable electric field and thus positional strain due to constant applied voltage across the material. FIG. 25A illustrates a symmetric sensor with uniform E-field. FIG. 25B illustrates a new sensor with triangular thickness cross section which establishes high strain at the tip greater then strain near the anchor. FIG. 25C illustrates a new sensor that involves an indented thickness geometry in which field strength is higher in the middle than near the ends.

It is to be understood that even though numerous characteristics and advantages of asymmetric sensors have been set forth in the foregoing description, together with details of the structure and function, the instant disclosure is illustrative only, and changes may be made in detail, especially in matters of shape, size, and arrangement of parts within the principles of asymmetric sensors to the full extent indicated by the broad general meaning of the terms in which the appended claims are expressed.

While example embodiments of asymmetric sensors have been described in connection with various computing devices/processors, the underlying concepts may be applied to any computing device, processor, or system capable of detection and measurement of mass change using a piezoelectric cantilever sensor. The various techniques described herein may be implemented in connection with hardware or software or, where appropriate, with a combination of both. Thus, the methods and apparatuses associated with asymmetric sensors, or certain aspects or portions thereof, may take the form of program code (i.e., instructions) embodied in tangible storage media. Examples of tangible storage media include floppy diskettes, CD-ROMs, DVDs, hard drives. When the program code is loaded into and executed by a machine, such as a computer, the machine becomes an apparatus for detection and measurement of mass change using impedance determinations. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations. As evident from the herein description, a tangible storage medium is not to be construed as a signal. As evident from the herein description, a tangible storage medium is not to be construed as a propagating signal.

The methods and apparatuses associated with asymmetric also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for detection and measurement of mass change using impedance determinations. When implemented on a general-purpose processor, the program code combines with the processor to provide a unique apparatus that operates to effectuate processes associated with asymmetric sensors.

The sensor of the present invention is capable of causing acoustic streaming in a fluid in contact with the sensor, when the sensor is excited with an excitation voltage. The excited sensor causes an oscillating mechanical disturbance in the fluid. The fluid and any suspended particles in the fluid are subject to acoustofluidic forces. Various acoustofluidic effects can arise based on different mechanisms, including acoustic streaming and radiation pressure.

The term acoustic streaming is commonly used to refer to the fluid flow due to the time-averaged effect of motion which is induced in a fluid environment dominated by its fluctuating components, such as (1) an oscillating structure or wall in contact with the fluid, or (2) a propagating sound wave through the fluid. The fluctuating components for the sensor in a fluid arise from the vibration of the sensor. Thus, the mechanistic origin of fluid flow is because the time-average of an oscillating quantity is not zero, but has a net mean. The approximate fluid motion can be described by the following equations:

μ∇²u₂−∇P₂+F_{STR}=0 (21)

F_{STR}=−ρ₀((u₁·∇)u₁+u₁(∇·u₁)) (22)

where the brackets < > indicate a time-averaged value of the function over a large number of cycles, u₂ and p₂ are the time-independent second-order velocity and pressure, ρ₀ and μ are the ambient, also called equilibrium, density and viscosity, respectively, u₁ is the oscillatory particle velocity, and F_{STR} is the forcing term which captures the time-averaged vibration effect.

The fluid-sensor coupling boundary conditions include velocity continuity, also called no-slip, and stress continuity at the sensor-fluid interface. Thus, suspended particles in the fluid will experience a vibration-associated force through viscous drag effects, which for spherical particles and a Newtonian fluid can be approximated reasonably by Stokes' law:

F_{STO}=6πμRvᵣ (23)

where F_{STO} is the force on the particle, μ is the viscosity, R is the particle radius, and vᵣ is the relative particle velocity with respect to the fluid.

In addition to the acoustofluidic forces on a suspended or immobilized particle, such as a cell or macromolecule with large hydrodynamic radius, there are also forces associated with the presence of acoustic pressure fields which oscillate about the equilibrium pressure as a result of periodic mechanical disturbance provided by the resonant sensor. The force experienced by a suspended particle is referred to as radiation pressure. The primary radiation force (F_{PRF}) can be derived considering solutions to the Wave equation and corresponding definitions of velocity and pressure:

$$\begin{matrix} {∇}^{2} ψ = \frac{1}{{c}^{2}} \frac{{\partial }^{2} ψ}{\partial \text{?}} & ( 24 ) \\ v ( r , t ) = ∇ ψ ( r , t ) & ( 25 ) \\ p ( r , t ) = ρ \frac{\partial }{\partial \text{?}} ψ ( r , t ) \\ \text{?} \text{indicates text missing or illegible when filed} & ( 26 )\end{matrix}$$

where ψ is the acoustic potential, t is the time, c is the speed of sound, v is the velocity, p is the acoustic pressure and ρ is the density. For the case of a spherical particle in a standing wave neglecting any scattering or wall effects, the force is given as:

$${F}_{PRF} = - \frac{π {R}^{3}}{3} {p}_{0}^{2} k {β}_{m} Φ sin ( 2 kx ) \qquad ( 27 )$$

where R is the particle radius, p₀ is the pressure amplitude, k is the wavenumber=ω/cₘ, ω is the frequency, c is the speed of sound, βₘ is the compressibility of the medium=1/ρₘcₘ², β_{P} is the compressibility of the particle=1/ρ_{P}c_{P}², ρₘ and ρ_{P} are the respective medium and particle densities, and Φ is given by the following relationship:

$$Φ = \frac{5 {ρ}_{p} - 2 {ρ}_{m}}{2 {ρ}_{p} + {ρ}_{m}} - \frac{{β}_{p}}{{β}_{m}} \qquad ( 28 )$$

Analogous with the concept of electrical impedance (Z) as the ratio of excitation voltage (ΔV) to resultant electric current (I)=ΔV/I, the specific acoustic impedance (Zₛ) of a sound wave is given as:

$$\text{?} ( r , ω ) = \frac{p ( r , ω )}{\text{?} ( r , ω )} \\ \text{?} \text{indicates text missing or illegible when filed} \qquad ( 29 )$$

where ω is the angular frequency and p and v are the respective pressure and velocity. In the absence of sound, a medium also has characteristic acoustic impedance (Z₀) given as:

Z₀−ρₘcₘ (30)

where ρₘ is the density of the medium and cₘ is the speed of sound in the medium. Thus, in presence of sound, Zₛ differs from Z₀.

The sensor of the present invention can cause disturbances in the surrounding liquid when the sensors are under an excitation voltage from a function generator (Agilent 33210A) which applied a sinusoidal excitation voltage of V volts peak-to-peak at a frequency f across the PZT layer of the sensor. The change in the initial dye stream trajectory increased as the excitation frequency approached the first mode resonant frequency, which suggests that the vibration-associated force on the fluid is directly related to the sensor vibration amplitude. The result also suggests that the vibration-associated force on the fluid is in the same direction as the surface deflection. The excitation voltage had only a small effect on the resonant frequency, indicating that maintaining a fixed excitation frequency at different voltage conditions is possible under this condition.

When pulse excitation voltages are applied to the sensors that is in a closed system, where fluid replacement is constrained, the acoustic stream in the closed system resembles a rotational flow. FIG. 45A shows a resultant image of the rotational trajectory of the dye. Thus, although the sensor vibration exerts a force on the fluid in the direction of the vibration deflection which for f=fₙ₌₁ is towards the wall, it also draws fluid in near the sensor tip given the constraint of the closed system.

With the resonant frequency changed to the second mode f=fₙ₌₂ under the same excitation voltage, the acoustic stream trajectory resembled the mode shape. The acoustic stream deflection is greater for f=fₙ₌₁ than f=fₙ₌₂, which can also be described through a larger deflection amplitude in the fundamental mode. When the sensor is horizontally-positioned and excited at either f=fₙ₌₁ or f=fₙ₌₂ under V=10 V, the stream resembles the cantilever mode shape. The vertical and horizontal experimental configurations are consistent with the location of the second mode nodal point and absence of the nodal point in the first mode, which is further consistent with fundamental cantilever mechanics. Thus, the sensor's resonant modes exert a position-dependent force on the fluid which causes the deflection of a flowing stream and creates rotational flow in a closed chamber.

The sensor excitation at the sensor's resonant modes also affects suspended particles in a liquid. When sensor is excited at f=fₙ₌₁ under V=10 V, the particles become trapped on both the cantilever short- and long-sides (FIGS. 46B-46D). Both the trapping zone and the number of trapped particles increase over time (FIGS. 46C and 46D). The short-side trapping zone may be slightly shifted toward the cantilever base and involved three trapped particle layers, while the long-side contains primarily two layers (FIG. 46D). When the particle concentration is increased, the trapping zone on the cantilever short-side may span the entire cantilever length and had about four trapped particle layers (FIG. 46E).

The trapped particles may be manipulated by switching the excitation frequency to a different resonant mode, herein referred to as mode switching. Switching from the first mode f=fₙ₌₁ to the second mode f=fₙ₌₂, the trapped particles reorganized within seconds into a configuration generated by the underlying transverse mode shape, indicating that the mechanism for cantilever-associated trapping under low mode excitation is directly related to the vibration amplitude. Further, switching the excitation frequency back to fₙ₌₁ caused the particles to return to the original configuration.

The trapped particles may be manipulated by using high-order modes and manipulated into geometric configurations including lines, which suggests the presence of standing acoustic waves, also called acoustic modes. However, unless the particles were initially trapped on the sensor by collection in a low-order mode, high frequency excitation with the random configuration in the initial condition may not cause cantilever-associated trapping, although it may still cause acoustic streaming. The line of trapped particles on the sensor produced by excitation at f=1.8 and 4.6 MHz may extended beyond the sensor tip, suggesting that the acoustofluidic forces acting on the particles are not purely towards the cantilever surface as is the case in the low-order modes. The absence of both cantilever-associated particle trapping and the presence of rotational acoustic streaming under both low and high excitation frequencies suggests a potential to release trapped particles by modulating the excitation frequency.

The trapped particles may be released by switching from low-order modes to high-order modes, for example switching from f=fₙ₌₁ to the 6.6 MHz mode or by switching the excitation signal from sinusoidal to noise which simultaneously excites many high-order modes. The particles may be rapidly released from the sensor surface within about 1 second. The released particles could be re-trapped by switching the excitation frequency back to f=fₙ₌₁.

### EXAMPLES

### Example 1

Parylene-c coated sensors were fabricated from PZT-5A as described in Sharma et al., “Piezoelectric cantilever sensors with asymmetric anchor exhibit picogram sensitivity in liquids,” Sens. Actuators B, vol. 153, pages 64-70 (2011), which is incorporated herein in its entirety by reference. A customized shadow mask was used for depositing a 100 nm thick gold (Au) layer on the cantilever top surface and a conductive path. An adhesive copper tape was attached to the Au layer near the cantilever base for connecting with a measurement instrument (e.g., impedance analyzer). The gold connection line was electrically-insulated by a spin-coated polyurethane layer (about 30 seconds at 1500 rpm) leaving only about 1 mm² Au at the distal end for detection of analytes. The fabricated sensors are shown in FIGS. 26A-26C.

The resonant frequency of the sensor was determined by monitoring the PZT layer impedance-based frequency response at a 100 mV excitation voltage with zero bias using an impedance analyzer (Agilent Model 4294A). Sensor frequency spectra were generated by a frequency sweep over the range of 1-250 kHz. The resonant frequency was calculated from continual sweeping of frequency within 5-10 kHz of the resonant frequency by a custom LabView® program. The resonance frequency was identified as the frequency at the maximum phase angle between the excitation voltage and the resulting current through the PZT.

The resonant frequency of the n^{th} transverse mode of the sensor depends on the effective cantilever mass (m_{c}) and the effective spring constant (k_{eff}) as:

$$\text{?} - {c}_{n} \sqrt{\frac{\text{?}}{\text{?}}} \\ \text{?} \text{indicates text missing or illegible when filed} \qquad ( 7 )$$

where k_{eff}=Ewt³/(12L³), m_{c}=ρLwt, cₙ=λₙ²/2π, L, w, and t are the cantilever length, width, and thickness, respectively, ρ is the density, and λₙ is the corresponding eigenvalue. Thus, changes in the resonant frequency (resonant frequency shift Δf) are associated with changes in both mass and stiffness as:

$$Δ f = \frac{1}{2} {f}_{n} ( \frac{Δ k}{k} - \frac{Δ m}{{m}_{n}} ) \qquad ( 8 )$$

which reduces to the following equation when stiffness changes are negligible, as is the case for surface detection of a majority of biomolecules:

$$Δ f = - \frac{1}{2} {f}_{n} ( \frac{Δ m}{{m}_{n}} ) \qquad ( 9 )$$

It is clear that when the mass of the sensor increases (e.g., when an analyte binds to the sensor's surface), there is a corresponding decrease in the resonant frequency for the sensor. The sensors showed two resonant modes at 21 and 105 kHz as indicated by the electromechanical impedance response of the PZT layer over 0-120 kHz (FIG. 27B). The position of the two resonant modes can be manipulated by varying the sensor geometry and the building material as described in Equation 7. Upon immersion of the sensor in a liquid, the two resonant modes decreased by 4.2±0.1 and 18.5±0.1 kHz, respectively. Since the cantilever Reynolds number was high (about 10⁴), the resonant frequency shift appears to be due to added mass on the sensor surface from the surrounding liquid.

In addition to determining resonant frequency shift Δf, the charge transfer resistance (ΔR_{CT}) for the sensors was also determined using the electrochemical impedance spectra (EIS). As shown schematically in FIG. 27A, R_{CT} is sensitive to immobilized biomolecules on the sensor (added mass). Thus, monitoring changes in R_{CT} may also be used for detection of biomolecules that can bind on the surface of the sensors. The sensor's electrochemical impedance spectra exhibit Randles-like behavior over a range of 10 mHz-100 kHz (FIG. 27C). In the absence of bound biomolecules, the Au surface of the sensor had an R_{CT} of 22±8Ω (n=5 sensors).

Metal deposition on the PZT layer also caused a resonant frequency shift for the sensor. The Au-layer on the sensor served as the working electrode. To deposit Au on the PZT layer, copper sulfate (CuSO₄, 1 M, deionized water (DIW)) and hydrogen tetrachloroaurate (III) trihydrate salt (HAuCl₄.3H₂O, 50 mM, DIW) were used in the respective copper and gold half-cells (FIG. 28A). A salt bridge (saturated KCl, diameter about 3 mm) was used to connect the two half cells. Voltage and current were measured by a multimeter (Fluka Model 289). The deposition of Au on the sensor can be controlled by the switch in the circuit shown in FIG. 28A.

As shown in FIG. 28B, the sensor's resonant frequency was first allowed to stabilize in the configuration with the switch in the open position which prevented gold deposition. After a steady-state resonant frequency was established, the switch was closed which allowed the spontaneous reduction reaction to occur thus initiating gold deposition. Both the resonant frequency and cell potential were recorded continuously. As shown in FIG. 28B, closing the switch caused a linear resonant frequency decrease at a rate of 1.4±0.5 and 16.4±4.6 Hz/min for the first and second modes, respectively. The measured cell potential was 0.8 V during the same period, which suggests deposition of solid Au may have involved reduction of Au complexes with different electron valences, other than just Au³⁺. Au deposition from dissolved Au-salts allowed addition of a small, yet measurable, mass to the sensor. After Au thin-film deposition occurred for about 10 minutes, the switch was opened again, which caused the resonant frequency to stabilize and the measured cell potential to decrease to 0 V.

FIG. 28B also shows that the sensor response was repeatable when the sensor was subjected to successive cycles of Au deposition. These results indicate that the sensor is capable of simultaneously measuring mass-change and electric current through the Au sensing surface. As shown in FIG. 28C, the current during the deposition period was about 50 μA. Since one mole of e⁻ is generated per mole of [AuCl₂]⁻ reduced, the Au deposition rate can be estimated as: (53 μA)/(96,485 C/mol e⁻)×(1 mol Au(s)/1 mol e⁻)=550 picomoles Au(s)/s. Therefore, the estimated mass deposition rate was 110 ng/s. It was observed that the rate of resonant frequency decrease was 1.7 Hz/min during mass deposition, and the mass-change sensitivity to mass deposited in the form of a thin-film was about 3.6 μg/Hz, which is significantly lower than the resonant frequency decrease observed for added mass due to biomolecule binding which does not form a coherent film.

The sensors were then used to detect surface biomolecule binding using both a model protein (bovine serum albumin) and thiolated single-stranded DNA (ssDNA). A three-electrode arrangement was used with the sensor being the working electrode, silver/silver chloride (Ag/AgCl) being the reference electrode, and platinum wire (Pt) being the counter electrode. Prior to using the sensor in detection experiments, the freshly sputtered 1 mm² Au electrode was cleaned in room temperature piranha solution (3:1 v/v H₂SO₄:H₂O₂) for about 30 seconds. The sensor was then rinsed immediately with copious amounts of deionized water and installed in a flow cell for the detection experiment.

Electrochemical impedance spectra (Interface 1000 Gamry Instruments, Warminster, Pa.) were generated in 50 mM Fe(CN)₆^{4-/3-} in PBS over the frequency range 10 mHz-100 kHz (DC bias=0 V) using an excitation voltage of 10 mV. EIS spectra were normalized by shifting the real part of the impedance, Re(Z), to the origin for comparison. R_{CT} was obtained by fitting data to a modified Randles equivalent circuit model (FIG. 27C). R_{CT} calculated from equivalent circuit models and R_{CT} based on the x-axis semi-circle distance formed by the impedance data in the Nyquist plot agreed well with a difference below about 6%.

Bovine serum albumin (BSA) and a DNA containing thiol end groups (thiolated ssDNA) were used as model molecules for biomolecule detection by the sensors as these two biomolecules readily bind to an Au surface on the sensor. The DNA sample used in the detection experiments was prepared from a thiolated DNA in a disulfide form of the ssDNA (HS-C₆T₆CCCTGAGTGTCAGATACAGCCCAGTAG, SEQ ID NO:1), purchased from Integrated DNA Technologies (IDT, Coralville, Iowa). The disulfide bond between two ssDNAs was reduced by adding 1 μL of 500 mM tris(2-carboxyethyl)phosphine (TCEP) to 300 μL of 1.4 μM DNA, which was subsequently mixed and allowed to react for about 60 minutes at room temperature. The reduction reaction produced thiolated ssDNA which was ready to be bound on the gold surface. In the meanwhile, the gold surface of the sensor was cleaned. Subsequently, the sensor was installed in a flow cell to allow the sensor to stabilize in flowing PBS at 500 μL/min. As shown in FIG. 29A, a freshly cleaned sensor gave an R_{CT} of 22±8Ω (n=5 different sensors). After a constant baseline in resonant frequency was obtained, the flow was switched from buffer to either a thiolated ssDNA (1.4 nM) or a BSA (200 μg/mL) solution and the flow was put in a re-circulation mode until a steady state of biomolecule binding was reached.

Regarding the chemisorption of BSA on the sensor, as shown in FIG. 29B, adsorption of BSA typically occurred within 15 minutes, as evidenced by a mass-caused resonant frequency shift of 30±7 Hz (n=2). The sensor was rinsed in situ by returning the flow to PBS which did not cause any resonant frequency change, indicating that the previous resonant frequency shift was caused by protein chemisorption on the sensor and was not due to experimental errors or noise. The electrochemical impedance spectrum of the sensor was re-measured by switching the flow back to BSA solution. The sensor showed an increase of R_{CT} to 50±18Ω (n=2) after BSA was adsorbed (FIG. 29A).

In the second experiment, chemisorption of thiolated ssDNA onto the sensor took about 40 minutes, which caused a 180±22 Hz shift (n=2) in the resonant frequency (FIG. 29B). Similar to the case of the BSA binding, an in situ rinse of the sensor (having bound ssDNA) with Tris-EDTA (TE) buffer caused no shift in resonant frequency, indicating that the resonant frequency shift was due to chemisorption of the ssDNA on the sensor. As shown in FIG. 29A, the sensor also showed a significant increase in the R_{CT} (394±65Ω; n=2), larger than that for BSA chemisorption, suggesting a more dense surface coverage by the ssDNA. These results suggest that the sensors have the ability to monitor surface-based biomolecule binding, namely by the two transduction mechanisms, Δf and ΔR_{CT}.

The Δf and ΔR_{CT} of the sensor may be measured simultaneously during the course of biomolecule binding on the gold surface of the sensor. The chemisorption of the short chain (C₆) thiol molecule mercaptohexanol (MCH) was monitored by tracking both changes in the resonant frequency and the charge transfer resistance. As shown in FIG. 30, when no analyte was bound on the sensor, both the resonant frequency and the charge transfer resistance of the sensor remained constant. However, upon contacting MCH (100 μL at 100 μM) with the sensor, the resonant frequency decreased and the charge transfer resistance increased in an exponential manner and took about 15 to 25 minutes to reach a steady state. Binding of MCH on the sensor caused a decrease in the resonant frequency (Δf about 30 Hz) and an increase in the charge transfer resistance (ΔR_{CT} about 1.5 kΩ). The modest shift in the resonant frequency in comparison to ssDNA chemisorption was due to the lower molecular weight of MCH compared to the molecular weight of ssDNA (MW about 7 kDa). The resonant frequency shift reached a steady state value by t=20 minutes, while ΔR_{CT} reached the steady state only at 32 minutes (FIG. 30).

Sensor resonant frequency decreases (Δf) caused by BSA and MCH binding, as shown in FIGS. 29B and 30, suggest that approximately the same mass of both BSA and MCH were bound to the sensor. Comparison of the corresponding electrochemical responses (ΔR_{CT}) caused by BSA and MCH binding suggests that the MCH induced a far greater charge transfer resistance than BSA, due to a high density MCH monolayer caused by MCH self-assembly on the sensor's Au surface. Thus, the sensors can provide two complementary measurements, i.e., changes in its mass and changes in its surface charge density. Since the measurements are obtained simultaneously and dynamically, additional insights into surface binding phenomena can be obtained, which are not as easily obtained by a single transduction mechanism using other methods.

### Example 2

In this example, sensors of the present invention were used to detect the toxin-producing cyanobacteria Microcystis aeruginosa via a species-specific region of 16S rRNA. M. aeruginosa strain (UTEX LB 2385) and Bold 3N Medium were purchased from the University of Texas-Austin (UTEX) culture collection (Austin, Tex.). The sensors were fabricated from diced Nickel (Ni)-electroded PZT chips (5×1×0.127 mm³, American Dicing, Liverpool, N.Y.). Electrical leads were attached to the top and bottom electrode faces of the chip via soldering near the end region. The chip's base region to which electrodes were attached was embedded into a glass cylinder (diameter about 3 mm) using epoxy, creating a conventionally-anchored piezoelectric cantilever sensor. Additional epoxy was added on one face of the cantilever base to create the desired anchor asymmetry. Details are described in Sharma et al., “Piezoelectric cantilever sensors with asymmetric anchor exhibit picogram sensitivity in liquids,” Sens. Actuators B, vol. 153, pages 64-70 (2011). The sensors were electrically-insulated by spin-coating a polyurethane layer (about a 2 day curing time at room temperature), followed by a subsequent chemical vapor-deposition of a parylene-c layer (10 μm thick). The sensors were then cured at 80° C. for about 24 hours. A 100 nm thick gold layer was sputtered on the sensors (by DeskIV, Denton Vacuum), which provided about 1 mm² of Au<111> sites for anchoring DNA probes (FIGS. 32A and 32B).

The sensors were first tested to ensure their suitability for DNA detection. The PZT impedance of the sensors was measured over the frequency range of 0-250 kHz, which showed various resonant modes corresponding to impedance-coupled transverse, torsional, lateral, and longitudinal modes (FIG. 32C). Specifically, the sensors exhibited transverse modes at 11.9 and 60.1 kHz which strongly couple to the high impedance change in the PZT layer. Immersion of the sensor in Tris-EDTA (TE) buffer caused a 2.5 and a 11.0 kHz decrease in the resonant frequency of the first and second modes, respectively, due to added mass on the sensor from the surrounding liquid. However, immersion in liquid only caused a minor reduction in Q-value (a measure of peak sharpness), suggesting negligible viscous damping. Thus, the measured resonant frequency shift was primarily due to inertial effects.

M. aeruginosa was cultured by inoculating 30 mL of sterile Bold 3N Medium with 200 μL of purchased starter culture (about 3×10⁷ cells/mL). During the inoculation, the culture was continuously purged with filtered air (about 3.5% carbon dioxide, CO₂) and exposed to continuous illumination (cool-white fluorescent light, 100 W, about 5,200 lux). The culture was inoculated for seven days at room temperature to reach a high cell density of about 2×10⁷ cells/mL. The M. aeruginosa cells were then harvested by centrifugation (2,500 rpm, 10 minutes, Clay Adams, DYNAC II Centrifuge) and re-suspended in 10 mM phosphate buffered saline (PBS, pH=7.4) with 0.01% w/w sodium azide to a final cell concentration of 5×10⁶ cells/mL. Nucleic acid (NA) was extracted from the cell suspension to create a stock NA-extract used in detection assays. 100 μL of M. aeruginosa cell suspension was added to 100 μL TE buffer and 400 μL Fermentas lysis solution followed by incubation at 80° C. for 30 minutes. The cell suspension was repeatedly sheared (20 gauge syringe) to assist disruption of cell walls. Chloroform was then gently added to the suspension (about 600 μL) followed by gentle mixing and centrifugation at 14,000 rpm for 2 minutes (Beckman Coulter, Microfuge® 18 Centrifuge). Fermentas precipitation solution (80 μL) was added to the aqueous phase extract (200 μL); then, 800 μL cold EtOH was added and the mixture was incubated overnight at 4° C. Samples were then centrifuged at 14,000 rpm for 30 minutes which formed a NA-pellet containing 16S rRNA and background genomic DNA. The pellet was then gently rinsed in cold EtOH twice and re-suspended in 300 μL 1 M TE buffer. The NA-extract was sheared through a sterile 30 gauge needle 25 times at about 80° C. to reduce the average size distribution of the NA strands to about 300 nucleotides in length, and then cooled to assay temperature as NA-extract stock for detection experiments. The NA-extract stock was serially diluted in ten-fold steps to provide NA-extract samples corresponding to samples containing 5×10¹ to 5×10⁵ M. aeruginosa cells/mL.

To simulate detection of M. aeruginosa cells in river water, 500 M. aeruginosa cells equivalent of cell suspension was added to 1 mL river water obtained from the Schuylkill River (Philadelphia, Pa., USA) to mimic a river water sample containing M. aeruginosa at 500 cells/mL. The river water sample was centrifuged at 14,000 rpm for 30 minutes. The supernatant was discarded and the cell pellet was re-suspended in 200 μL TE buffer to begin the NA extraction protocol discussed above. For river water-based detection, NA-extract was melted and sheared at a slightly higher temperature (98° C.) and rapidly chilled to 0° C. prior to being used in detection experiments.

A thiolated DNA probe for detecting the 16S rRNA of M. aeruginosa (strand A, see Table 2) was synthesized and its selectivity was verified using the basic local alignment search tool (BLAST) of the National Institute of Health's (NIH) GenBank. Strand A contained a thiol group at the 5′ end for immobilization on the gold surface of the sensor. The synthetic thiolated DNA probe was reconstituted in TE buffer (10 mM Tris, 1 mM EDTA, pH=7.9, 1 M NaCl) and stored at −22° C. before immobilization on a gold surface.

TABLE 2
Single strand DNAs

| Name | Sequence | MW(kDa) |
|---|---|---|
| DNA Probe | HS(CH₂)₆T₆CCC TGA GTG TCA GAT ACA GCC CAG TAG | 10.4 |
| (Probe Strand A, | | |
| SEQ ID NO: 2) | | |
| 16S rRNA | UGGGAAGAACAUCGGUGGCG . . . | about |
| (Target Strand B, | . . . AAAGCGAGCUACUGGGCUGUAUCUGACACUCAGG | 97.5 |
| SEQ ID NO: 3) | G | |
| NP-DNA probe | CGCCACCGATGTTCTTCCCAT₆(CH₂)₃SH | 8.1 |
| (Enhancement | | |
| Strand C, | | |
| SEQ ID NO: 4) | | |
| Random RNA | N₂₂ | 7.0 |
| (Random Strand D, | | |
| SEQ ID NO: 5) | | |

Prior to immobilization, the disulfide form of the DNA probe (1.4 μM) was reduced by adding 1 μL 500 mM TCEP to 300 μL of the DNA probe and incubating at room temperature (about 25° C.) for about 45 minutes. For tagging the NP-DNA probe (Strand C of Table 2) to gold nanoparticles (NPs), Au NPs were washed with TE buffer, centrifuged at 14,000 rpm for 45 minutes and re-suspended in TE buffer. Immobilization of NP-DNA probe on Au NPs was done by mixing 200 μL of TE-washed Au nanoparticles (at a concentration of 5.7×10¹² particles/mL) with 300 μL of TCEP-reduced strand C probe for about 1.5 hours. The labeled-NPs were washed twice to remove unbound NP-DNA probe, with centrifugation at 14,000 rpm for 45 minutes.

The hybridization between the DNA probe (strand A) and the target 16S rRNA strand (strand B) in the NA-extract was verified by PicoGreen fluorescence. The sensors, immobilized with the DNA probe, were hybridized with the target 16S rRNA, followed by incubation in the dye-containing cuvette for 5 minutes in the dark. Emission spectra were obtained with the sensor surface positioned at a 45° angle with respect to incident radiation. Fluorescence spectra over a wavelength range of 500-600 nm were obtained at a 490 nm excitation wavelength with a 1 nm slit width (Spectrofluorometer, PTI, Birmingham, N.J.), which indicated hybridization between the DNA probe and the target 16S rRNA.

Before being used for detection experiments, the freshly Au-sputtered sensors were cleaned with piranha solution at room temperature for about 30 seconds followed by a copious deionized water rinse. The sensor was then installed in a flow cell and its resonant frequency was allowed to stabilize under a continuously flowing buffer and an AC driving voltage of 100 mV with 0 DC bias (Agilent 4294A), FIG. 31A. Detection of mass addition on the sensors was done by sweeping a frequency range near resonance with the applied AC voltage and continually tracking the resonant frequency. After steady state was reached, the flow was switched to the reduced DNA probe solution (strand A) and the flow format was switched to a once-through mode to completely replace the loop volume with the DNA probe solution. After about 4 mL DNA probe solution was allowed to flow through the flow loop, the flow format was returned to a re-circulation mode. When DNA probe was chemisorbed onto the Au sensor surface, the mass of the sensor increased, which decreased the resonant frequency of the sensor. Subsequently, 1 mL of 100 nM MCH was injected directly into the DNA probe reservoir and the flow format switched to a once-through mode until 1 mL MCH solution was removed from the loop, a time at which the flow format was returned to the re-circulation mode. MCH can cover the Au surface of the sensor that was un-occupied by the DNA probe, which caused a further small resonant frequency decrease (added more mass to the sensor). The sensor was then rinsed by switching the flow from the MCH solution to the TE buffer while at the same time switching the flow format to the once-through mode until the MCH was completely removed from the loop. A minimal rinse time of about the flow cell time constant ([loop volume+cell volume]/flow rate=[3 mL+0.3 mL]/(0.5 mL/min) about 6.5 min) was used in all cases. The sensors were then prepared for detecting the target 16S rRNA. The sensor surface preparation time from start to finish was about 90 minutes.

Detection of cyanobacteria was performed by monitoring the sensor's response to solutions containing various concentrations of M. aeruginosa NA-extract (FIGS. 31B-31C). The detection assay started by installing the prepared sensor in a custom flow cell (FIG. 31B), and allowing the resonant frequency to reach steady state in TE buffer with the flow in re-circulation mode. Hybridization between the immobilized DNA probe (strand A) and the target 16S rRNA (strand B) over a concentration range of 5×10¹ to 5×10⁵ cells/mL caused various levels of sensor mass increase, and thus, different levels of decrease in sensor resonant frequency. The sensor detection time post-sensor preparation and NA extraction was less than one hour, affected by the probe-target hybridization rate. Following target detection, the flow loop was subsequently rinsed and sensing enhancement and verification steps were performed by introducing the secondary Au NPs that were labeled with NP-DNA probe (strand C, see FIG. 31C). As more mass was added on the sensor from the Au NPs, the resonant frequency shifted proportionally to the sensor-bound 16S rRNA. The time period for completing sensing enhancement and verification was also affected by the hybridization rate, but was on average about 45 minutes. Thus, the assay may be completed in about 90 minutes, after the target nucleic acid extraction from M. aeruginosa cells.

There were four controls used in the detection of cyanobacteria with the same batch of sensors. The four controls were: (1) examination of sensor response in the absence of injection of the buffer, (2) examination of sensor response to injections of a buffer which lacked a binding analyte, (3) examination of prepared-sensor response to injection of random RNA (c=5 nM), and (4) examination of prepared-sensor response to extract from river water not spiked with M. aeruginosa cells. Controls (1) and (2) addressed potential false signals which may arise from fabrication or apparatus abnormalities, such as defects in device coating or pressure effects, respectively, while controls (3) and (4) addressed potential false signals caused by nonspecific binding between the sensor and background RNA or organic material present in river water.

The first control was done by allowing the sensor to stabilize in the flow cell under continuously flowing buffer while tracking the resonant frequency over a 2-3 hour time period (typical full assay length including preparation). The second control was done by allowing the sensor to stabilize in flowing buffer and subsequently making injections of buffer which lacked binding analyte to the flow cell in the same fashion as done for addition of the DNA probe while at the same time monitoring the resonant frequency. The third and fourth controls were done by making an injection of sample containing either random RNA oligos or river water extract, respectively, subsequent to a TE buffer rinse and DNA probe and MCH immobilization while at the same time monitoring the resonant frequency shift.

As shown in FIG. 31B, the resonant frequency remained constant in the absence of a binding analyte and the resonant frequency shift was within about 3 Hz (a noise level) over a three hour period. When the flow was changed from TE buffer to DNA probe, the resonant frequency decreased significantly relative to the noise level.

The M. aeruginosa 16S rRNA detection results were as follows. As shown in FIG. 33A, introduction of 1 mL of DNA probe (14 fM; strand A in Table 2) caused an exponential resonant frequency decrease over the next 20 minutes, ultimately reaching a steady state of resonant frequency that was 22 Hz lower than the initial value. The resonant frequency decrease was over nine times the noise level in the measurement. This decrease in resonant frequency is consistent with net increase in the mass added to the sensor surface due to the DNA probe immobilized on the sensor surface through chemisorption of the thiol end group to Au<111> sites. Injection of DNA probe at sequentially higher concentrations should cause further added mass response, and thus an additional resonant frequency decrease could both verify the initial sensor immobilization response and allow characterization of the sensitivity to DNA probe chemisorption over a range of DNA probe concentrations. As shown in FIG. 33A, introduction of DNA probe at a ten-fold higher concentration caused a further decrease in the resonant frequency with a transient period similar to the initial response. The sensor response to further increases in DNA probe concentration was examined up to 14 pM (FIG. 33A). Finally, in situ rinsing of the sensor was done by switching back to TE buffer in a once-through mode. The rinsing caused only negligible changes in the resonant frequency, indicating that the DNA probe remained strongly bound to the sensor surface.

FIG. 33B shows cumulative sensor resonant frequency decrease (average of 3 sensors) as a function of DNA probe concentration. A semi-log linear empirical relationship was observed: (−Δf)=A+B log(c), where A and B are empirical characteristic sensor constants corresponding to concentration given on a molar basis. Sensor response to DNA probe immobilization yielded sensor constants A=378.9 Hz and B=24.4 Hz. From the sensor response correlation (−Δf)=A+B log(c), one can obtain a sensitivity parameter, such as d(−Δf)/dc=B/c which has the units of resonant frequency shift per molar unit (Hz/M). The log-linear correlation suggests that the device is more sensitive at lower concentrations than at higher concentrations, which is an attractive property of the sensor of the present invention.

The sensors were then used to detect the 16S rRNA at a low concentration where the sensors are more sensitive. The DNA probe (strand A; Table 2) was immobilized on the sensors by injection of 1 mL of 1.4 nM DNA probe to ensure good surface coverage. Such a concentration was experimentally found to provide a good surface packing density on the sensor that yielded sensitive detection of 16s rRNA hybridization. As shown in FIG. 34A, chemisorption of the DNA probe at a 1.4 nM concentration caused a 195 Hz shift in the resonant frequency over a typical binding period of about 1 hour. The empty Au<111> sites (not bound by the DNA probe) were next covered by mercaptohexanol (MCH, 100 nM; 1 mL) injection, which may also displace non-oriented DNA probe bound to Au via the nitrogeneous bases. The MCH binding caused a further resonant frequency shift of about 10 Hz. The sensor surface then underwent in situ rinsing by switching the flow to TE buffer in a once-through mode. The rinsing by TE buffer caused negligible resonant frequency changes, indicating the DNA probe and MCH remained bound to the sensor (FIG. 34A). At this stage, the sensor was prepared for exposure to an NA sample containing the melted and sheared 16S rRNA target.

Samples of NA-extract of M. aeruginosa that were serially diluted in ten-fold steps were individually introduced to the prepared sensors. The sensor's sensitivity for 16S rRNA detection was examined by switching the flow to 50 cell/mL of NA-extract (about 33 fg 16S rRNA/mL). As shown in FIG. 34A, the sensor's resonant frequency decreased by 47 Hz over the next 40 minutes due to 16S rRNA hybridization to surface-bound DNA probe. In FIG. 34B, NA extracts with two other cell concentrations were exposed to the sensors, 5×10² and 5×10⁵ cells/mL. It was then observed that: (1) the time scale of sensor response decreases with decreasing concentration of M. aeruginosa, and (2) detection at the higher concentration occurs in less than two hours. The control experiments in which random RNA or un-spiked river water extract were introduced to the prepared sensor caused no detectable change in the resonant frequency. The sensor's resonant frequency shift after exposure to NA-extract samples corresponding to concentrations of from 5×10¹ to 5×10⁵ cells/mL showed a semi-log-linear relationship with A=−41.4 Hz and B=29.5 Hz (FIG. 35A).

The binding of target 16S rRNA on the sensor via the DNA probe was verified by measuring PicoGreen fluorescence, which is indicative of DNA-RNA double strands (DNA probe-16S rRNA hybridization on the surface of sensors). As shown in the inset of FIG. 35A, the fluorescence signal on the sensor with bound 16S rRNA was significantly higher than the fluorescence signal of a sensor that was not exposed to 16S rRNA (i.e. with only DNA probe bound on the sensor's surface). Both target-hybridized and control sensors showed maximum fluorescence intensity near 525-530 nm which agrees with PicoGreen properties (see FIG. 35A).

The binding of 16S rRNA to the DNA probe on the sensor was further confirmed and amplified using a secondary hybridization with NP-DNA-labeled Au nanoparticle (NP), where the NP-DNA (strand C in Table 2) was designed to hybridize with the distal end of a captured target 16S rRNA (FIG. 31C). Specifically, after exposing a prepared sensor to M. aeruginosa NA extract samples, the flow cell was rinsed with TE buffer to remove unbound 16S rRNA strands from the flow loop and subsequently allowed to re-stabilize. Flow was then switched to a solution containing Au NP labeled with NP-DNA. As shown in FIGS. 31C and 35B, the second hybridization between labeled-Au NPs and the distal region of the target 16S rRNA added much mass to the sensor surface, causing a significant decrease in the resonant frequency. The Au NP enhancement of sensor response had a similar relative enhancement for low and high M. aeruginosa concentrations (5×10¹ and 5×10⁵ cells/mL), which more than doubled the initial resonant frequency shifts at both concentrations.

The feasibility of using the sensors for detection of M. aeruginosa in river water was also studied. River water samples were spiked with a known number of M. aeruginosa, 500 cells/mL. The NA was extracted from the river water samples and introduced to prepared sensors. Using the same detection procedure as discussed above, the sensors were capable of detecting 500 cells/mL in river water, thereby providing a verifiable resonant frequency shift of 26±23 Hz. DNA labeled Au-NP hybridization gave an additional resonant frequency shift of 22±11 Hz. These results demonstrate that the sensors of the present invention can successfully detect M. aeruginosa in river water at a concentration of 500 cells/mL or more.

The relationship between the resonant frequency shift and the target 16S rRNA concentration is empirical (−Δt)=A+B×log(c), with and without Au NP enhancement, where c is the concentration of 16S rRNA in the sample. As shown in FIG. 36, the best fitting semi-log linear correlation using the concentration data gave values of A=−10.5 and B=17.8 Hz. By extrapolating from this relationship, if a minimum acceptable signal-to-noise ratio of about 3 is assumed, the limit of detection is predicted to be about 14 cells/mL. The nanoparticle labeled DNA strand amplified the sensor response. Thus, as shown n FIG. 36, the NP-enhanced detections gave values of A=−40.2 and B=44.9 Hz. The value of B for NP-enhancement is over 50% higher than the value for non NP-enhancement (44.9 Hz vs. 28.6 Hz), suggesting that NP-enhancement improved the detection limit by about 50%. Thus the estimated detection limit for M. aeruginosa with NP-enhancement is expected to be less than 10 cells/mL.

### Example 3

Electrically-insulated sensors were fabricated from lead zirconate titanate type-5A (PZT-5A, from PiezoSystems, Woburn, Mass.) as described in Sharma et al., “Piezoelectric cantilever sensors with asymmetric anchor exhibit picogram sensitivity in liquids,” Sens. Actuators B, vol. 153, pages 64-70 (2011). Briefly, a 100 nm thick gold (Au) layer was deposited on the cantilever top surface leading off the cantilever as a conductive pathway. An adhesive copper tape was attached to the Au lead near the cantilever base for connection with measurement instruments. The sensors are shown schematically in FIG. 37A. The freshly sputtered Au surface was cleaned with piranha solution (3:1 H₂SO₄:H₂O₂) for about 30 seconds followed by rinsing with copious amounts of deionized water. The cleaned sensor was then dried under a nitrogen stream.

It has been found that the sensors of the present invention manifest sensitive high-order modes over the 0.01-1 MHz frequency range. Although such modes have a complex mode shape at high frequency, the modes below 250 kHz are typically transverse modes. For example, as shown in FIG. 37B, typical sensors used in this example exhibited first through fourth order transverse modes at 9.5, 49, 118, and 182 kHz, respectively, each of which exhibited strong impedance coupling. Immersing the sensor in human serum (HS) caused a decrease in the resonant frequency (Δf=2, 9, 15, and 10 kHz, respectively) of the four modes due to an increase in the effective mass on the sensor added by the HS. The second through fourth order transverse modes were used in this example as indications of the mass increase on the sensors.

It is known that a vibrating object causes a resultant flow in its surrounding fluid, referred to as acoustic streaming, which may play a critical role in attenuating nonspecific binding of proteins on the vibrating object. A transverse vibration in the sensor was shown to cause streaming flow using neutrally-buoyant particles (100 μm diameter). Images of the particle movement at one-second time intervals showed that traverse vibration of the sensor caused significant streaming velocity near the sensor surface (FIGS. 38A-38B). The particle indicated by the arrow in FIG. 38A moved a distance of about six times the cantilever thickness (t=127 μm) in one second as evidenced by its final position in FIG. 38B (out of view behind the cantilever). This experiment was repeated over ten times at various excitation voltages and particle concentrations. The results demonstrate that: (1) transverse mode vibration in the sensors caused streaming, and (2) streaming velocities of about 0.7 mm/s can be generated at a 10 V excitation voltage. A complementary procedure using dye visualization was also performed to confirm that acoustic streaming occurred at the lower relative excitation voltages of 0.1 to 1 V. However, when the sensor was excited off-resonance below 200 kHz, acoustic streaming was not observed.

The sensors were then used to study whether the transverse vibration leads to a reduction of nonspecific adsorption of proteins on the sensor surface. Serum proteins such as bovine serum albumin (BSA) or human serum (HS) proteins can nonspecifically bind to the sensor surface, which will decrease the resonant frequency of the sensor. Such nonspecific binding decreases the sensitivity of the sensor for detecting a specific analyte. In this example, the resonant frequency of the sensors across the thickness dimension was determined by impedance spectroscopy (Agilent 4294A) across the thickness dimension. The sensor was either fully immersed in a liquid in a batch format or installed in a flow cell under continuously flowing liquid (about 0.5 mL/min), where the liquid contained serum proteins. For example, the resonant frequency of the sensor decreased as BSA (from Sigma-Aldrich) was nonspecifically bound to the surface of the sensor, or increased as the BSA coverage on the sensor was reduced (release of nonspecifically bound protein). The fractional reduction in BSA coverage (θ_{red}) on the sensor is correlated to the resonance frequency change as follows:

$${θ}_{red} = \frac{f ( t ) f ( t = 0 ) \text{?} Δ {f}_{H} ( t )}{f ( t = \text{?} ) - f ( t = 0 ) \text{?} Δ {f}_{H} ( t = \text{?} )} \\ \text{?} \text{indicates text missing or illegible when filed} \qquad ( 10 )$$

where f(t) is the resonant frequency at time t and Δf_{H}(t) is the sum of frequency decreases attributed to the increase in mass when a change is made from lower to higher excitation voltages.

Release of nonspecifically bound proteins from the sensor surface was first monitored by a fluorescence assay. A freshly cleaned sensor (without excitation) was immersed in 50% human serum (HS) solution (1:1 serum:DIW) for one hour to allow HS proteins to bind nonspecifically to the sensor. The HS was from Innovative Research (Novi, Mich.)). The sensor was then removed from the HS solution and rinsed thrice with deionized water (DIW). The rinsed sensor was placed in a fresh centrifuge tube containing 500 μL of DIW for 10 minutes for releasing HS protein from the sensor. After 10 minutes, the concentration of HS proteins in the DIW due to desorption of HS protein from the sensor surface was measured using NanoOrange® dye (from Invitrogen (Carlsbad, Calif.)) according to the vendor-provided protocol.

An excitation voltage Vₑₓ may be applied to the sensor to cause vibration, thus facilitating releasing of HS proteins from the sensor surface. Different excitation voltages (10, 100, or 1000 mV) were applied during the 10 minute release period. The fractional reduction in nonspecific binding (θ_{red}) was calculated from:

$${θ}_{red} = \frac{\text{?} ( \text{?} ) I ( \text{?} = 0 )}{I ( \text{?} ) - I ( {V}_{ex} = 0 )} \\ \text{?} \text{indicates text missing or illegible when filed} \qquad ( 11 )$$

where I(Vₑₓ) is the fluorescent intensity measured in the liquid while the sensor was resonated at Vₑₓ, and V_{ex,max} is the maximum excitation voltage examined for release (1 V). The value I(Vₑₓ=0) represents the base level of fluorescent intensity when no excitation voltage is applied. The release of nonspecifically bound BSA from the sensor was confirmed by a NanoOrange (NO) fluorescence assay. As shown in FIG. 40, increasing the excitation voltage resulted in the samples yielding a higher fluorescence intensity in the bulk liquid after the 10 minute release period.

Electrochemical impedance spectroscopy (Gamry Instruments, Interface 1000, Warminster, Pa.) was used to study the reduction of nonspecific adsorption of proteins on the sensor. The EIS had a three-electrode arrangement with a platinum (Pt) counter electrode, silver/silver chloride (Ag/AgCl) reference electrode, and the sensor of the present invention as the working electrode. All measurements were carried out in 50 mM ferrocyanide/ferricyanide (Fe(CN)₆^{4-/3-}) prepared in PBS. EIS measurements were obtained over a frequency range of 100 mHz-100 kHz with a step size of 10 points/decade at 10 mVᵣₘₛ vs. the open circuit voltage (V_{OC}) and zero DC bias. Cyclic voltammetry (CV) measurements were obtained at a scan rate of 50 mV/s with a step size of 1 mV between −0.2 and 0.8 V versus Ag/AgCl. Electrochemical impedance measurements were obtained in a batch cell at a steady state while the sensor was either not excited or excited at 10, 100, or 1000 mV.

Electrochemical impedance spectra were generated for sensors under a static condition (0 V) or when vibrating at resonance (about 50 to 150 kHz) with various excitation voltages ranging from 10 to 1000 mV. Charge transfer resistance (R_{CT}) was computed and used as an indication of the level of surface adsorption. As shown in FIG. 39A, the electrochemical frequency response was independent of Vₑₓ in the absence of BSA and followed a Randles-like equivalent circuit. The excitation voltage caused a change in R_{CT} within ±3Ω from its value a under non-excited condition (27Ω). Experiments repeated with several sensors (n=3) confirmed that increasing the vibration intensity in the absence of BSA causes a maximum change in R_{CT} of about 3%.

The baseline for nonspecific adsorption of BSA on the sensor when no excitation voltage (Vₑₓ=0 V) was applied to the sensor was determined by repeat experiments involving immersion of the sensor in 1 mg/mL of BSA solution in a batch measurement format. The sensor was placed in the BSA solution with no excitation voltage to allow the adsorption of BSA to reach a steady state in R_{CT} (FIGS. 39A and 39B). As shown in FIG. 39A, BSA adsorption caused almost an order of magnitude increase in R_{CT} from 27 to 145Ω over a 20 minute period (curve a in FIG. 39A). Then, the sensor's resonant frequency was measured at stepwise increasing excitation voltages, where the excitation voltages caused sensor vibration and release of nonspecifically bound BSA from the sensor. When a higher excitation voltage was applied to the sensor, which caused additional release of nonspecifically bound BSA, a decrease of R_{CT} from the baseline was observed (curves b-d in FIG. 39A). Further, under an excitation voltage of Vₑₓ=10 mV, the resonant frequency had an exponential increase of 21 Hz over a 20 minute transient period with an apparent first-order rate constant of kₐₚₚ=0.1 min⁻¹, which indicated a quick release of nonspecifically bound BSA from the sensor. When the excitation voltage Vₑₓ was increased from 10 to 100 mV, a second exponential increase of 19 Hz was observed over a similar transient time period (kₐₚₚ=0.02 min⁻¹). Finally, increasing Vₑₓ from 100 to 1000 mV caused a further increase of 18 Hz in the resonant frequency with an associated rate of k_{obs}=0.05 min⁻¹ (FIG. 39B). This experiment demonstrates that increasing excitation voltage causes increased vibration of the sensor, which causes release of nonspecifically bound BSA from the sensor and thereby increases the resonant frequency.

The observed increase in the resonant frequency and the decrease in the R_{CT} under excitation voltage are consistent with a lower level of adsorption of nonspecific proteins on the sensor surface in the presence of vibration. Furthermore, the simultaneous monitoring of the electrochemical (R_{CT}) and mass-change sensing (Δf) makes the measurement especially reliable. It should be noted that vibration of the sensor caused a negligible change in temperature of the sensor, and thus, temperature effects associated with vibration are not the source of the reduction in nonspecific adsorption. The results suggest that the mechanism of reduction in nonspecific adsorption by excitation voltages involves a number of physical phenomena dependent on parameters including fluid properties, such as density (ρ) and viscosity (μ), as well as parameters associated with the resonant mode, such as transverse deflection amplitude (A) and angular frequency (ω). Fractional reduction in nonspecific binding (θ_{red}) can be calculated from:

$${θ}_{red} = \frac{{R}_{CT} ( {V}_{ex} ) - {R}_{CT} ( {V}_{ex} = 0 )}{{R}_{CT} ( \text{?} ) - {R}_{CT} ( \text{?} = 0 )} \\ \text{?} \text{indicates text missing or illegible when filed} \qquad ( 12 )$$

where R_{CT} is the charge transfer resistance and the subscript notation follows the fluorescence value labeling (see Equation (11)).

Additional cyclic voltammetry (CV) experiments were used to further confirm release of nonspecifically bound proteins by vibration of the sensor. Specifically, the initial adsorption of BSA in the absence of vibration caused a decrease in the redox peak current. Introduction of a 10 mV vibration intensity without disturbing the sensor caused about a 20% recovery in the peak current value after a similar transient period to that observed for electrochemical impedance measurements. Subsequent increases in the excitation voltage to 100 and 1000 mV led to a further recovery of the peak current values, which suggests that vibration facilitated BSA desorption from the sensor surface.

In FIG. 41A, a comparison was made among θ_{red} obtained using electrochemical impedance, mass-sensing and the complementary fluorescence assay. The three different measures showed good trend agreement, within experimental error. Interestingly, as shown in FIG. 41B, the average of the three techniques exhibited empirical dependence on the excitation voltage, namely, the magnitude of transverse deflection, as:

θ_{red}=1−e^{-αV}^{ₙ} (13)

where Vₙ is the normalized excitation voltage defined as Vₑₓ/V_{ex,max} and α is a dimensionless empirical constant characterizing the vibration effect on binding reduction. A numerical fit of the averaged BSA data gave α=9.3. Based on the fact that when the term αVₙ equals unity, θ_{red} is 0.632, one can estimate that Vₑₓ=(1/α)V_{ex,max} and that about 110 mV is required to release 63.2% of the adsorbed BSA. Thus, the parameter a provides a measure of the binding strength between the surface and the adsorbed protein (lower numerical value indicates higher binding energy).

Excitation voltages were also applied to determine their effect on strong binding thiolated ssDNA, which has a higher affinity for Au<111> sites than serum proteins. Thiolated DNA binds to Au with about a fourfold higher binding energy (about −45 kcal/mol) than BSA. Chemisorption of the ssDNA to a sensor was obtained by incubating a freshly cleaned sensor in 1.4 nM TCEP-reduced ssDNA for 90 minutes. An increase in the R_{CT} at about 480Ω was observed, which was about five times larger than the change in the R_{CT} caused by adsorption of the BSA. As shown in FIGS. 41A-41B, introducing vibration to the sensor with immobilized ssDNA, even at the highest excitation voltage examined (1000 mV), only caused a very small change in the R_{CT}, which suggests that ssDNA is more strongly immobilized on the sensor and not easily removed by vibration caused by excitation voltages. The empirical constant α for ssDNA was much lower (α=0.08), which reflects the stronger binding energy of ssDNA to Au. Thus, the excitation voltage required to remove 63.2% of the ssDNA was calculated to be about (1/0.08)V_{ex,max}=12.5 V. The observed very small change in the R_{CT} was likely due to the removal of weakly bound ssDNA via relatively weaker Au-nitrogenous base or van der Waals interactions, and not the ssDNA bound by the much stronger Au<111>-sulfur chemisorption bond.

Thus, in a practical application, the vibration intensity may be adjusted to optimize the binding of a specific analyte to the sensor while reducing nonspecific binding of contaminants and impurities. If desired, the vibration intensity may be reduced after release of nonspecific binding has occurred allowing the binding of previously impeded species to occur in a triggered fashion. The ability to release nonspecifically bound proteins in the context of a practical assay contributes to an improvement in the signal response and reduced nonspecific binding for detection in complex matrix backgrounds.

The electrochemical impedance measurements were repeated for BSA concentrations ranging from 0.2-3.6 mg/mL. As shown in FIG. 42, surface vibration (about 50 kHz) reduced adsorption at all concentrations examined Adsorption is commonly modeled following a Langmuir adsorption isotherm as:

$$θ = \frac{Kc}{1 + Kc} \qquad ( 14 )$$

where θ is the fractional coverage, c is the concentration of BSA in the bulk solution, and K is an effective equilibrium constant. The data in FIG. 42 suggest that the excitation voltage destabilizes the adsorbed BSA by adding energy to the adsorbed protein state through various momentum transfer and chemical effects.

FIG. 42 also suggests that surface vibration influences the equilibrium state of the system. Sensor vibration may contribute to several important protein release forces, such as body force, lift force, hydrodynamic streaming force, intermolecular forces, and electrical forces. The additive energetic contribution of these forces (ΔE) acting over the length-scale of a protein molecule (Lₚ) can be expressed as a sum of surface strain energy (E_{Au}), body force energy (E_{B}), and hydrodynamic energy from acoustic streaming (E_{ST}) as:

ΔE=E_{Au}+E_{B}+E_{ST} (15)

Equation (15) can be further expanded in terms of vibration-associated state variables: axial position (x), surface vibration amplitude (A), and angular frequency (ω) as:

$$Δ E = [ ( \frac{\text{?}}{\text{?}} ) {A}_{p} ε + \frac{1}{2} {m}_{p} {v}^{2} + μ \frac{\partial {v}_{x}}{\partial y} {A}_{p} {L}_{p} ] Ψ ( x ) \\ \text{?} \text{indicates text missing or illegible when filed} \qquad ( 16 )$$

where dγ/dε=0.096 eV/Å² is the strain derivative of the strain energy for Au<111>, Aₚ is the protein cross-sectional area (=πDₚ²/4), Dₚ is the diameter of the protein, ε is the strain in the metal layer about [L²+A²)^{1/2}−L]/L based on small angle approximation where L is the cantilever length, μ is the liquid viscosity, vₐ is the acoustic streaming velocity,

$$\frac{\partial {v}_{x}}{\partial y}$$

is the shear rate about vₐ/δ_{BL} where vₐ is the tangential streaming velocity at the boundary layer edge and δ_{BL} is the boundary layer thickness estimated as about 10 μm⁴³, mₚ is the protein mass, \dot{v} is the resonant mode velocity about Aω, and Ψ(x) is the cantilever mode shape.

The hydrodynamic and body forces involve out-of-plane vibration as do transverse modes of cantilevers. The energy contributions are comparable in the following order: E_{Au}>E-_{B}>E_{ST}, which indicates that the actual mechanism of releasing nonspecifically bound proteins is complex and likely involves various contributions.

The Piezoelectric cantilever motion of the sensors of the present invention may be described by following coupled equations which comprise the equation of motion, definition of strain, and constitutive equations, respectively:

$$\begin{matrix} \frac{\partial \text{?}}{\text{?} \text{?}} - ρ \frac{{\partial }^{2} \text{?}}{\partial {t}^{2}} = 0 & ( 17 ) \\ {S}_{ij} = \frac{1}{2} ( \frac{\partial {u}_{i}}{\partial {x}_{j}} + \frac{\partial {u}_{i}}{\partial {x}_{j}} ) & ( 18 ) \\ {T}_{ij} = {c}_{ijkl}^{B} {S}_{kl} - \text{?} {E}_{m} & ( 19 ) \\ {D}_{i} = {e}_{ijk} {S}_{jk} + {μ}_{ij} {E}_{j} \\ \text{?} \text{indicates text missing or illegible when filed} & ( 20 )\end{matrix}$$

where T is the stress, u is the displacement, S is the strain, x is the position, c^{E} is the elasticity, e is the coupling matrix, D is the electric displacement, E is the electric field, μ is the relative permittivity, the subscripts i, j and k refer to the three principal coordinates, and their transpose is indicated by the indices l, m and n; t is the time, and ρ is the density. The equations are subject to the cantilever mechanical boundary conditions which correspond to one fixed end and one unconstrained end, as well as the electrical boundary conditions imposed by deposited electrodes and applied potentials.

### Example 4

In this example, the effects of a vibrating sensor on a fluid in contact with the sensor were studied. The vibrating sensor, under an excitation voltage, may cause an oscillating mechanical disturbance in the fluid. The fluid and any suspended particles in the fluid are subject to acoustofluidic forces. Various acoustofluidic effects can arise based on different mechanisms, including acoustic streaming and radiation pressure.

The term acoustic streaming is commonly used to refer to the fluid flow due to the time-averaged effect of motion which is induced in a fluid environment dominated by its fluctuating components, such as (1) an oscillating structure or wall in contact with the fluid, or (2) a propagating sound wave through the fluid. The fluctuating components for the sensor in a fluid arise from the vibration of the sensor. Thus, the mechanistic origin of fluid flow is because the time-average of an oscillating quantity is not zero, but has a net mean. The approximate fluid motion can be described by the following equations:

μ∇²u₂−∇P₂+F_{STR}=0 (21)

F_{STR}=−ρ₀((u₁·∇)u₁+u₁(∇·u₁)) (22)

where the brackets < > indicate a time-averaged value of the function over a large number of cycles, u₂ and p₂ are the time-independent second-order velocity and pressure, ρ₀ and μ are the ambient, also called equilibrium, density and viscosity, respectively, u₁ is the oscillatory particle velocity, and F_{STR} is the forcing term which captures the time-averaged vibration effect.

The fluid-sensor coupling boundary conditions include velocity continuity, also called no-slip, and stress continuity at the sensor-fluid interface. Thus, suspended particles in the fluid will experience a vibration-associated force through viscous drag effects, which for spherical particles and a Newtonian fluid can be approximated reasonably by Stokes' law:

F_{STO}=6πμRvᵣ (23)

where F_{STO} is the force on the particle, μ is the viscosity, R is the particle radius, and vᵣ is the relative particle velocity with respect to the fluid.

In addition to the acoustofluidic forces on a suspended or immobilized particle, such as a cell or macromolecule with large hydrodynamic radius, there are also forces associated with the presence of acoustic pressure fields which oscillate about the equilibrium pressure as a result of periodic mechanical disturbance provided by the resonant sensor. The force experienced by a suspended particle is referred to as radiation pressure. The primary radiation force (F_{PRF}) can be derived considering solutions to the Wave equation and corresponding definitions of velocity and pressure:

$$\begin{matrix} {∇}^{2} ψ = \frac{1}{{c}^{2}} \frac{{\partial }^{2} ψ}{\partial {t}^{2}} & ( 24 ) \\ v ( r , t ) = ∇ ψ ( r , t ) & ( 25 ) \\ p ( r , t ) = ρ \frac{\partial }{\partial \text{?}} ψ ( r , t ) \\ \text{?} \text{indicates text missing or illegible when filed} & ( 26 )\end{matrix}$$

where ψ is the acoustic potential, t is the time, c is the speed of sound, v is the velocity, p is the acoustic pressure and ρ is the density. For the case of a spherical particle in a standing wave neglecting any scattering or wall effects, the force is given as:

$${F}_{PRF} = - \frac{π \text{?}}{3} {p}_{0}^{2} k {β}_{m} Φ sin ( 2 kx ) \\ \text{?} \text{indicates text missing or illegible when filed} \qquad ( 27 )$$

where R is the particle radius, p₀ is the pressure amplitude, k is the wavenumber=ω/cₘ, ω is the frequency, c is the speed of sound, βₘ is the compressibility of the medium=1/ρₘcₘ², βₚ is the compressibility of the particle=1/ρₚcₚ², ρₘ and ρₚ are the respective medium and particle densities, and Φ is given by the following relationship:

$$Φ = \frac{\text{?} \text{?} - 2 {ρ}_{m}}{2 {ρ}_{p} + {ρ}_{m}} - \frac{{β}_{p}}{{β}_{m}} \\ \text{?} \text{indicates text missing or illegible when filed} \qquad ( 28 )$$

Analogous with the concept of electrical impedance (Z) as the ratio of excitation voltage (ΔV) to resultant electric current (I)=ΔV/I, the specific acoustic impedance (Zₛ) of a sound wave is given as:

$$\text{?} ( r , ω ) = \frac{p ( r , ω )}{\text{?} ( r , ω )} \\ \text{?} \text{indicates text missing or illegible when filed} \qquad ( 29 )$$

where ω is the angular frequency and p and v are the respective pressure and velocity. In the absence of sound, a medium also has characteristic acoustic impedance (Z₀) given as:

Z₀−ρₘcₘ (30)

where ρₘ is the density of the medium and cₘ is the speed of sound in the medium. Thus, in presence of sound, Zₛ differs from Z₀.

The sensors (FIGS. 43A and 43B) were used to study effects on particles suspended in a fluid. These sensors were fabricated as described in Sharma et al., “Piezoelectric cantilever sensors with asymmetric anchor exhibit picogram sensitivity in liquids,” Sens. Actuators B, vol. 153, pages 64-70 (2011). As shown in FIG. 43C, the sensor had an impedance response which qualitatively resembled a modified RLC circuit. The sensor behaves capacitively at low frequency as indicated by a phase angle (φ) of about −90°, and inductively at high frequency as indicated by a φ of about +90° with a transition occurring at about 2.5 MHz. In addition, various peaks exist due to the sensor's resonant modes. The sharp change in phase angle corresponding to changes of resonance frequency is due to the change in material electrical resistance and net charge accumulation on the electrode faces which occur under high strain. Thus, the sensor exhibited various impedance coupled resonant modes at both low and high frequency, referred to as low- and high-order modes, respectively (FIG. 43C). For example, the first two low-order modes are found at about 10 and 70 kHz in air, while prominent high-order modes were present at 0.3, 1.8, 4.6, and 6.6 MHz.

The impedance spectrum of the sensor in a liquid (e.g., water) was also measured. As shown in FIG. 43C, immersion in DIW caused a resonant frequency and Q-value decrease for all the resonant modes present, though to different extents. For example, the low-order modes showed a resonant frequency decrease due to the added mass of the surrounding fluid. The other modes, such as the 4.6 and 6.6 MHz modes, showed a reduced relative resonant frequency [=(fₐᵢᵣ−f_{water})/f_{water}] change upon liquid immersion. Interestingly, a similar trend was also observed for Q-value reductions, indicating that the sensor fluid-structure interaction differs depending on the resonant frequency and resonant mode type. Specifically, the low-order modes and high-order mode near 1.8 MHz experienced the expected minor Q-value reduction in liquid given the high cantilever Reynolds number. However, the resonant modes near 4.6 and 6.6 MHz experienced a significantly reduced effect on Q-value. The fundamental and second transverse modes are presented in FIGS. 44A and 44B, respectively, for comparison with flow visualization data obtained in this example. The calculated resonant frequencies of f_{n=1=11.2} kHz and fₙ₌₂=69.1 kHz agree reasonably with the present experimental results of 12.2 and 66.9 kHz. Thus, it was found that the fabricated sensors contain various resonant modes with different mode shape, added-mass response, and damping response.

The disturbances in the surrounding liquid created by vibration of the sensor were first studied using dye visualization. Trypan Blue dye was diluted by a factor of two with 10 mM PBS which gave the optimum density difference with DIW that served as the liquid medium for all flow visualization studies. A density-driven laminar flow dye stream was generated along the face of a vertically-positioned sensor through its surrounding quiescent DIW as shown in the far left panel of FIG. 44C. After a steady state flow profile was established, the dye stream trajectory was monitored when the sensor was under a range of different excitation frequency and voltage levels. The excitation voltage was provided by a function generator (Agilent 33210A) which applied a sinusoidal excitation voltage of V volts peak-to-peak at a frequency f across the PZT layer of the sensor. As shown in FIG. 44C, the change in the initial dye stream trajectory increased as the excitation frequency approached the first mode resonant frequency. This result suggests that the vibration-associated force on the fluid is directly related to the sensor vibration amplitude. The result also suggests that the vibration-associated force on the fluid is in the same direction as the surface deflection. The excitation voltage had only a small effect on the resonant frequency, indicating that maintaining a fixed excitation frequency at different voltage conditions is possible under this condition.

Next, pulse excitation voltages were applied to the sensors to determine the effect of sensor vibration in a closed system, where fluid replacement is constrained. The dye stream was first allowed to reach a steady state under no vibration. Next, sensor vibration was generated at a first resonant mode f=fₙ₌₁ and V=10 V until the dye stream was fully deflected which took about 3 seconds. At that time, the excitation voltage was turned off allowing the dye stream to return to and adopt the original linear trajectory. The process was then repeated to allow the dye to enter the region with rotational flow present. FIG. 45A shows a resultant image of the rotational trajectory of the dye. Thus, although the sensor vibration exerts a force on the fluid in the direction of the vibration deflection which for f=fₙ₌₁ is towards the wall, it also draws fluid in near the sensor tip given the constraint of the closed system.

When the resonant frequency was changed to the second mode f=fₙ₌₂ under the same excitation voltage, as shown in FIGS. 45A and 45B, the dye trajectory under excited conditions resembled the mode shape. The net dye stream deflection was greater for f=fₙ₌₁ than f=fₙ₌₂, which can also be described through a larger deflection amplitude in the fundamental mode. When the sensor was horizontally-positioned, the dye was directly loaded onto its face via a syringe. After dye loading, the syringe was removed and the dye was allowed to settle directly on the face of the sensor. The sensor was then excited at either f=fₙ₌₁ or f=fₙ₌₂ under V=10 V. As shown in FIGS. 45D and 45E, horizontal sensors also provided imaging of the cantilever mode shape. The vertical and horizontal experimental configurations are consistent with the location of the second mode nodal point and absence of the nodal point in the first mode, which is further consistent with fundamental cantilever mechanics. Thus, the sensor's resonant modes exert a position-dependent force on the fluid which causes the deflection of a flowing stream and creates rotational flow in a closed chamber.

The effect on suspended particles in a liquid of the sensor's resonant modes was also studied. Particles were prepared at 10-100 mg beads/mL following vendor-provided protocols. The particles were suspended by adding the particles into DIW containing about 0.05% Tween, heating the solution to about 70° C., and gently mixing the solution. The particle solution was then allowed to cool to room temperature prior to use. A sensor was installed in a 1 cm cuvette containing a neutrally-buoyant particle solution (100 μm, 10 mg/mL). When no excitation voltage was applied (t=0), the particles were in a random distribution in the solution (FIG. 46A). The sensor was then excited at f=fₙ₌₁ under V=10 V. Over the course of the next 90 minutes, the particles were trapped on both the cantilever short- and long-sides (FIGS. 46B-46D). As shown in FIG. 46B, a single trapped particle layer was observed after 1 minute. Both the trapping zone and the number of trapped particles increased over the next 90 minutes (FIGS. 46C and 46D). The short-side trapping zone remained slightly shifted toward the cantilever base and involved three trapped particle layers, while the long-side contained primarily two layers (FIG. 46D). When a higher particle concentration (100 mg/mL) was used, the trapping zone on the cantilever short-side spanned the entire cantilever length and had about four trapped particle layers (FIG. 46E).

Next, the trapped particles were manipulated by switching the excitation frequency to a different resonant mode, herein referred to as mode switching. Initially, particles were first trapped at the first mode f=fₙ₌₁ until steady state was reached (about 20 minutes). The excitation frequency was switched to the second mode f=fₙ₌₂. As shown in FIGS. 47A-47C, the trapped particles reorganized within seconds into a configuration generated by the underlying transverse mode shape, suggesting that the mechanism for cantilever-associated trapping under low mode excitation is directly related to the vibration amplitude. Further, switching the excitation frequency back to fₙ₌₁ caused the particles to return to the original configuration.

The trapped particles were also manipulated using high-order modes. As shown in FIGS. 48A-48C, the particles could also be manipulated into geometric configurations including lines, which suggest the presence of standing acoustic waves, also called acoustic modes. The increase in the number of trapped particle lines upon switch from 1.8 to 4.6 MHz shown in FIGS. 48A-48C also suggests the presence of acoustic modes. However, unless the particles were initially trapped on the sensor by collection in a low-order mode, high frequency excitation with the random configuration in the initial condition did not cause cantilever-associated trapping, although it did cause significant dye mixing by acoustic streaming. It was also observed that the line of trapped particles shown in FIGS. 48B-48C produced by excitation at f=1.8 and 4.6 MHz extended beyond the sensor tip, suggesting that the acoustofluidic forces acting on the particles are not purely towards the cantilever surface as is the case in the low-order modes. The absence of both cantilever-associated particle trapping and the presence of rotational acoustic streaming under both low and high excitation frequencies suggests a potential to release trapped particles by modulating the excitation frequency.

The trapped particles were released by switching from low-order modes to high-order modes. Particles were first allowed to be trapped on the sensor in the first mode where f=fₙ₌₁ until a steady-state was reached as shown in FIG. 49A. The excitation frequency was then switched to the 6.6 MHz mode or by switching the excitation signal from sinusoidal to noise which simultaneously excites many high-order modes. For example, as shown in FIGS. 49B-49D for the case of a switch to noise excitation, the particles were rapidly released from the sensor surface within about 1 second. The released particles could be re-trapped by switching the excitation frequency back to f=fₙ₌₁. The same particle release was observed upon switching again to the 6.6 MHz mode, which suggests that the trapped particles can be released by exciting a single high-order mode.

While asymmetric sensors of the present invention have been described in connection with the various embodiments of the various figures, it is to be understood that other similar embodiments can be used or modifications and additions can be made to the described embodiments of asymmetric sensors without deviating therefrom. Therefore, asymmetric sensors should not be limited to any single embodiment, but rather should be construed in breadth and scope in accordance with the appended claims.

What is claimed is:

1. A sensor comprising:
a first portion comprising a first surface and a second surface; wherein the first surface is opposite the second surface;
a first electrode coupled to the first surface of the first portion; and
a second electrode coupled to the second surface of the first portion,
wherein the first electrode and the second electrode are asymmetric.

2. The sensor of claim 1, wherein a length of the first electrode differs from a length of the second electrode.

3. The sensor of claim 1, wherein a width of the first electrode differs from a width of the second electrode.

4. The sensor of claim 1, wherein a placement of the first electrode with respect to the first surface differs from a placement of the second electrode with respect to the second surface.

5. The sensor of claim 1, wherein an end of the first electrode is angled.

6. The sensor of claim 1, wherein an end of the second electrode is angled.

7. The sensor of claim 1, wherein the first portion comprises a piezoelectric material.

8. The sensor of claim 1, wherein the sensor is configured as a cantilever sensor.

9. A sensor comprising:
a first portion comprising:
a first surface and a second surface; wherein the first surface is opposite the second surface;
a proximate end opposite a distal end; and
a first side opposite a second side; and
an asymmetrically configured base coupled to the first portion.

10. The sensor of claim 9, wherein the base is coupled only to one of the first side or the second side.

11. The sensor of claim 9, wherein the base is coupled only to one of the first surface or the second surface.

12. The sensor of claim 9, wherein:
a length of a portion of the base coupled to the first surface differs from a length of a portion of the base coupled to the second surface.

13. The sensor of claim 9, wherein:
a length of a portion of the base coupled to the first side differs from a length of a portion of the base coupled to the second side.

14. The sensor of claim 9, wherein:
a width of a portion of the base coupled to the first surface differs from a width of a portion of the base coupled to the second surface.

15. The sensor of claim 9, wherein:
a width of a portion of the base coupled to the first side differs from a width of a portion of the base coupled to the second side.

16. The sensor of claim 9, wherein an end of the base is angled.

17. The sensor of claim 9, wherein the first portion comprises a piezoelectric material.

18. The sensor of claim 9, wherein the sensor is configured as a cantilever sensor.

19. A method comprising:
exposing at least a portion of a sensor to a medium, wherein the sensor comprises:
a first portion comprising a first surface and a second surface; wherein the first surface is opposite the second surface;
a first electrode coupled to the first surface of the first portion; and
a second electrode coupled to the second surface of the first portion,
wherein the first electrode and the second electrode are asymmetric;
measuring a resonance frequency of the sensor;
comparing the measured resonance frequency with a baseline frequency; and
when the measured resonance frequency differs from the baseline frequency, determining that an analyte is present in the medium.

20. A method comprising:
exposing at least a portion of a sensor to a medium, wherein the sensor comprises:
a first portion comprising a first surface and a second surface; wherein the first surface is opposite the second surface;
a first electrode coupled to the first surface of the first portion; and
a second electrode coupled to the second surface of the first portion,
wherein the first electrode and the second electrode are asymmetric;
measuring an impedance of the sensor;
comparing the measured impedance with a baseline impedance; and
when the measured impedance differs from the baseline impedance, determining that an analyte is present in the medium.
